(19) United States
(12) Patent Application Publication
(10) Pub. No.: US 2011/0052867 A1
(43) Pub. Date: Mar. 3, 2011

(54) LAMINATED FILM AND PACKAGING MATERIAL COMPOSED OF THE SAME

(75) Inventors: Gouhei Yamamura, Shiga (JP); Saori Sakamoto, Shiga (JP); Shigeru Tanaka, Shiga (JP); Masahiro Kimura, Shiga (JP)

(73) Assignee: TORAY INDUSTRIES, INC., Tokyo (JP)

(21) Appl. No.: 12/810,884

(22) PCT Filed: Dec. 24, 2008
(86) PCT No.: PCT/JP2008/073367

§ 371 Date: Jun. 28, 2010

(30) Foreign Application Priority Data
Dec. 28, 2007 (JP) 2007-338827
Sep. 25, 2008 (JP) 2008-245422

(51) Int. Cl. B32B 27/08

(52) U.S. Cl. 428/141; 428/483; 428/461

(57) ABSTRACT

A laminate film includes Layer A of a resin composition (A) composed mainly of a polylactic acid-based resin, Layer B of a resin composition (B) composed mainly of a polyolefin-based resin laminated to Layer A, and Layer C of a resin composition (C) laminated to Layer A, wherein the modulus in a longitudinal direction of the film is 2.0 to 7.0 GPa and, after being subjected to heat treatment at 100° C. for 5 minutes, thermal shrinkage in the longitudinal direction and in a width direction of the film is 10% or less and 20% or less, respectively.

### RELATED APPLICATIONS

This is a §371 of International Application No. PCT/JP2008/073367, with an international filing date of Dec. 24, 2008 (WO 2009/084518 A1, published Jul. 9, 2009), which is based on Japanese Patent Application No. 2007-338827, filed Dec. 28, 2007, and 2008-245422, filed Sep. 25, 2008, the subject matter of which is incorporated by reference.

### TECHNICAL FIELD

This disclosure relates to a laminated film excellent in processability, film-forming property and gas barrier property. In more detail, it relates to a laminated film suitable for packaging materials.

### BACKGROUND

Polyolefin-based resins such as polypropylene are used in many fields since it is inexpensive, high in moldability and excellent in balance among physical properties such as rigidity. As film materials, in particular, they are widely used as wrapping film for foods such as candy. However, due to problems with petroleum-derived materials, such as depletion of resources, generation of carbon dioxide during production and incineration and little decomposability after disposal, attention has been drawn in recent years to biodegradable resins and to plant-derived or biologically derived materials.

In particular, among the biodegradable resins, polylactic acid-based resin consisting of a polyester resin composition whose main component is a lactic acid monomer is expected as a biopolymer which can replace resins made from fossil resources such as petroleum, since it has become possible to economically produce lactic acid that can serve as the monomer, by fermentation using microorganism, from a biomass such as maize as raw material, and also since it has a melting point as high as about 170° C. and can be melt-molded.

However, polylactic acid-based resin is poor in thermal resistance, flexibility and the like and has difficulty in processability when used as a film, especially, in stabilities during printing, vapor deposition and bag production. It has only poor satisfactory gas barrier property, which is an important characteristic of packaging material for practical use.

On the other hand, a technology for compounding a plurality of resins is widely known as polymer alloy technology, and widely applied for the purpose of improving defects of the component polymers.

JP-H05-179110 A has disclosed a biodegradable thermoplastic resin composition produced by mixing and dispersing a polyolefin-based resin in a biodegradable thermoplastic resin, in which the polyolefin-based resin is partly degenerated. However, JP '110 aims to control biodegradability, and it contains no disclosure at all on characteristics such as thermal resistance and processability nor description on a method to solve the problem for obtaining a film excellent in processability and gas barrier property.

JP-H06-263892 A has disclosed a biodegradable thermoplastic resin film obtainable from a composition that is produced by adding a compatibilizer to a mixture of an aliphatic polyester and a polyolefin-based resin. However, JP '892 relates to disclosure of a film having a high biodegradability and thermal adhesiveness, but a method to solve the problem for obtaining a film excellent in processability and gas barrier property is not suggested.

In JP 2003-301077 A, a polyolefin-based resin composition which contains polyolefin-based resin, polylactic acid-based synthetic resin component, vinyl acetate/ethylene copolymer and the like is disclosed. However, JP '077 aims to achieve a stable productivity during processing into a sheet-like product and there is no disclosure about processability when the film is processed or about its gas barrier property. Any means to solve the problem for obtaining a film excellent in processability and gas barrier property are not suggested at all.

In JP 2005-68232 A, a biodegradable blend resin, in which a biodegradable resin and a polyolefin-based resin are blended, is disclosed. However, JP '232 relates to a disclosure that aims to maintain, in a laminated film, high interlayer adhesive strength, and there is no suggestion at all about stabilities during printing, vapor deposition and bag production or gas barrier property.

In JP 2005-248160 A, a biodegradable plastic material comprising a biodegradable polymer, a polymer other than the biodegradable polymer and a compatibilizer is compounded is disclosed. However, in the disclosure of JP '160, a method to solve the problem for obtaining a film excellent in processability and gas barrier property is not suggested at all.

In JP 2005-307128 A, a polylactic acid-based resin composition which contains a polylactic acid-based resin, a crystalline polypropylene-based resin composition in which the crystalline polypropylene-based resin contains a degenerated polypropylene resin, and an inorganic filler, is disclosed. However, in the disclosure of JP '128, any means to solve the problem for obtaining a film excellent in processability and gas barrier property are not suggested at all.

In addition, in JP 2006-326952 A and JP-H14-019053 A, there are disclosures about a laminated film and a sheet having a polyolefin-based resin layer and a polylactic acid-based resin layer. However, these relate to films or sheets having thermal shrinkage, and there is no disclosure about a method for obtaining a film which is excellent in processability such as at vapor deposition or lamination, or in gas barrier property.

As stated above, when any of the methods is employed, it is difficult to obtain a film which satisfies all characteristics such as thermal resistance, processability and gas barrier property, and a further improvement has been demanded.

It could therefore be helpful to provide a film that is composed mainly of a polylactic acid-based resin and that is excellent in processability, especially stabilities during printing, vapor deposition and bag production and in practical characteristics such as gas barrier property while maintaining a high productivity inherent in polyolefin film.

### SUMMARY

We provide:
1) A laminated film comprising at least the three resin layers of Layer A of a resin composition (A) composed mainly of a polylactic acid-based resin, Layer B of a resin composition (B) composed mainly of a polyolefin-based resin and Layer C of a resin composition (C), Layers B, A and C being laminated in this order, characterized in that the modulus in the longitudinal direction is 2.0 to 7.0 GPa and that after being subjected to heat treatment at 100° C. for 5 minutes, the thermal shrinkage in the longitudinal direction and in the width direction is 10% or less and 20% or less, respectively.
2) A laminated film as described in the above paragraph 1, characterized in that, after being subjected to heat treatment at 120° C. for 15 minutes, the thermal shrinkage in the longitudinal direction and in the width direction is 10% or less and 20% or less, respectively.
3) A laminated film as described in either of the above paragraphs 1 and 2, characterized in that the center-line average roughness Ra of the surface of Layer B in the laminated film is 10 nm to 85 nm.
4) A laminated film as described in any of the above paragraphs 1 to 3, characterized in that the resin composition (A) contains a polyolefin-based resin.
5) A laminated film as described in any of the above paragraphs 1 to 4, characterized in that the resin composition (B) comprises as its main component at least one polyolefin-based resin selected from the group consisting of polypropylene, ethylene-propylene random copolymer, ethylene-propylene block copolymer, ethylene-propylene-butene random copolymer and propylene-butene random copolymer.
6) A laminated film as described in any of the above paragraphs 1 to 5, characterized in that the resin composition (C) comprises as its main component polypropylene, ethylene-propylene random copolymer, ethylene-propylene block copolymer, ethylene-propylene-butene random copolymer, propylene-butene random copolymer, or polylactic acid-based resin.
7) A laminated film as described in any of the above paragraphs 1 to 6, characterized in that Layers A and B and/or Layers A and C are laminated via Layer D of an adhesive resin (D).
8) A laminated film as described in any of the above paragraphs 1 to 7, characterized in that at least one resin composition selected from the group consisting of the resin composition (A), the resin composition (B) and the resin composition (C) contains an adhesive resin (E).
9) A laminated film as described in any of the above paragraphs 1 to 8, characterized in that at least one resin composition selected from the group consisting of the resin composition (A), the resin composition (B) and the resin composition (C) contains a drawing auxiliary (F).
10) A laminated film as described in any of the above paragraphs 1 to 9, characterized in that Layer C has heat sealability.
11) A laminated film as described in any of the above paragraphs 1 to 10, characterized in that the ratio of the modulus in the longitudinal direction to the modulus in the width direction ((modulus in longitudinal direction)/(modulus in width direction)) is 0.3 to 0.75.
12) A laminated film described in any of the above paragraphs 1 to 11, characterized in that a vapor deposited layer composed of a metal or a metal oxide is provided on the side of Layer B in the laminated film.
13) A laminate film as described in the above paragraph 12, characterized in that a coated layer is provided between the vapor deposited layer composed of the metal or the metal oxide and the layer B in the laminated film.
14) A packaging material that contains, in its constitution, a laminated film as described in any of the above paragraphs 1 to 13.

The film is excellent in processability and gas barrier property and can be preferably used in general industrial applications and films for wrapping material.

### DETAILED DESCRIPTION

We provide a laminate film comprising at least the three resin layers of Layer A of a resin composition (A) composed mainly of a polylactic acid-based resin, Layer B of a resin composition (B) composed mainly of a polyolefin-based resin and Layer C of a resin composition (C). Layers B, A and C are laminated in this order, that is to say, Layer A locates between Layer B and Layer C. It is preferable that Layer A is the main layer which is the thickest among the resin layers. The reason why Layer B whose main component is polyolefin-based resin is the surface layer is because it can improve the film-forming property. That is, in cases where a biaxially drawn film as described later is produced, it is possible to prevent sticking to the rolls during roll-drawing, compared to cases where a layer whose main component is polylactic acid-based resin is the surface layer. The reason why Layer C is the surface layer is the same as above in cases where the resin composition (C) comprises polyolefin-based resin as its main component. In cases where the resin composition (C) comprises polylactic acid-based resin as its main component, the reason is, as mentioned later, that heat sealability will be achieved by using, as Layer C, amorphous polylactic acid-based resin which makes close contact with Layer A. The reason why it is preferable that Layer A is the main layer is because the overall biomass content of the film increases and the biodegradability also improves when a layer composed of a resin composition (A) whose main component is polylactic acid-based resin (Layer A) is used as the main layer in the laminated film.

The main component is defined as the component that accounts for the largest weight percentage in the total weight of all components of the resin compositions that constitute each layer of the laminated film, which is taken as 100 wt %.

It is important that the modulus in the longitudinal direction is 2.0 to 7.0 GPa, more preferably 2.0 to 5.0 GPa. It is particularly preferable that the modulus is in the range of 2.0 to 7.0 GPa not only in the longitudinal direction, but also in the transverse direction. When the modulus in the longitudinal direction is in the range of 2.0 to 7.0 GPa, the film is excellent in mechanical strength, and the handling properties in processes such as printing, vapor deposition or package production are improved. Furthermore, the deviation of printing pitch is prevented, leading to improved quality. In addition, elongation of film by a tension at later processes is suppressed and generation of defects in vapor-deposited film is prevented, and the gas barrier property of the vapor-deposited film also improves.

A modulus in the longitudinal direction in the range of 2.0 to 7.0 GPa can be achieved by adequately controlling the drawing temperature and draw ratio in the longitudinal and transverse directions within a preferable range under the drawing conditions specified later. Other preferred methods include re-drawing in the longitudinal direction after carrying out sequential biaxial drawing, and addition of a high melt tension polypropylene containing long chain branches up to 1 to 100 wt % in the resin composition (B) which accounts for 100 wt %.

It is important that the thermal shrinkage in the longitudinal direction is 10% or less and the thermal shrinkage in the width direction is 20% or less after being subjected to heat treatment at 100° C. for 5 minutes. More preferably, the thermal shrinkage in the longitudinal direction is −3% to 6% and the thermal shrinkage in the width direction is −4% to 4%. Still more preferably, the thermal shrinkage in the longitudinal direction is −1% to 6% and the thermal shrinkage in the width direction is −2% to 4%. Handling properties are improved and the processability for printing, vapor deposition, package production and the like is improved if the thermal shrinkage after being subjected to a heat treatment at 100° C. for 5 minutes is 10% or less in the longitudinal direction and 20% or less in the width direction.

In addition, it is preferable that the thermal shrinkage in the longitudinal direction is 10% or less and the thermal shrinkage in the width direction is 20% or less, after being subjected to heat treatment at 120° C. for 15 minutes. More preferably, the thermal shrinkage in the longitudinal direction is −3% to 6% and the thermal shrinkage in the width direction is −4% to 4%. Still more preferably, the thermal shrinkage in the longitudinal direction is −1% to 6% and the thermal shrinkage in the width direction is −2% to 4%. The film will be excellent in thermal resistance and dimensional stability and the processability for printing, vapor deposition, package production and the like is especially improved if the thermal shrinkage after being subjected to heat treatment at 120° C. for 15 minutes is 10% or less in the longitudinal direction and 20% or less in the width direction. In addition to the improvement in thermal resistance, dimensional stability, processability and printing accuracy, the film will also be improved in terms of the gas barrier property of the vapor-deposited film resulting from vapor deposition of the laminated film if the thermal shrinkage in the longitudinal direction is 0% to 4% and the thermal shrinkage in the width direction is −1% to 2%, and especially preferably if the shrinkage in the longitudinal direction is 0% to 2% and the thermal shrinkage in the width direction is −1% to 1.5%.

A value of the thermal shrinkage in the longitudinal direction in the range of 10% or less and a value of the thermal shrinkage in the width direction in the range of 20% or less after being subjected to heat treatment at 100° C. for 5 minutes can be achieved by appropriately controlling the heat fixation temperature, relaxation ratio and relaxation temperature during heat relaxation treatment within the preferable range mentioned later. That is, in the case of “drawing conditions of polylactic acid-based resin” mentioned later, the temperature of heat fixation or relaxation after drawing is preferably 120 to 150° C., more preferably 125 to 145° C. and still more preferably 130 to 140° C., and the relaxation ratio is preferably 2 to 15%, more preferably 5 to 10% and still more preferably 8 to 10%. In the case of “drawing conditions of polyolefin-based resin” mentioned later, the temperature of heat fixation or relaxation after drawing is preferably 155 to 170° C., more preferably 158 to 167° C. and still more preferably 160 to 165° C. and the relaxation ratio is preferably 2 to 15%, more preferably 5 to 10% and still more preferably 8 to 10%. As the polylactic acid-based resin contained as the main component in the resin composition (A), it is also effective to use a polylactic acid-based resin in which L-form lactic acid units or D-form lactic acid units are contained up to 95 mol % or more to control the thermal shrinkage in such a range. In the case where two or more polylactic acid-based resins are contained, calculations should be based on the weight average lactic acid units of the respective polylactic acid-based resins.

In view of the gas barrier property or printing accuracy in the case where a vapor deposited layer is provided on the surface of Layer B, the center-line average roughness Ra of the surface of Layer B in the laminated film is preferably 10 nm to 85 nm, more preferably 10 nm to 70 nm and still more preferably 10 nm to 60 nm. If the surface roughness exceeds 85 nm, vapor deposition barrier property will not be developed easily since vapor deposition defects may arise in the case where a laminated film has a vapor deposited layer, whereas the handling properties during processing may become poor and troubles may be caused by blocking, electrification or the like, if the surface roughness is less than 10 nm.

The surface roughness of the surface of Layer B can be controlled in the range of 10 to 85 nm by such ways as increasing the areal draw ratio within the preferable range mentioned later, or suppressing the crystallinity of the resin composition (B) which constitutes Layer B, or adding a hydrocarbon resin that is substantially free of polar groups and/or a terpene resin that is substantially free of polar groups into the resin composition (B) up to a preferable amount as mentioned later.

It is preferable that the ratio of the modulus in the longitudinal direction to the modulus in the width direction ((modulus in longitudinal direction)/(modulus in width direction)) is 0.3 to 0.75, more preferably 0.5 to 0.75 and still more preferably 0.65 to 0.75. If the ratio of the modulus in the longitudinal direction to the modulus in the width direction (modulus in the longitudinal direction)/(modulus in the width direction)) is less than 1.0, it indicates that the strength in the width direction is larger than that in the longitudinal direction. If the ratio of the modulus in the longitudinal direction to the modulus in the width direction (modulus in longitudinal direction)/(modulus in width direction) is in the range of 0.3 to 0.75, wrinkles will not occur because of the high tensile strength in the width direction, and the film after being wound will have better appearance. The difference in barrier properties between the outer and core portions of the wound film will be decreased.

The ratio of the modulus in the longitudinal direction to the modulus in the width direction (modulus in longitudinal direction)/(modulus in width direction) can be controlled in the range of 0.3 to 0.75 by increasing the draw ratio in the width direction higher than the draw ratio in the longitudinal direction within the preferable range of drawing conditions mentioned later.

The resin composition (A) that constitutes Layer A of the laminated film is a resin whose main component is polylactic acid-based resin.

The polylactic acid-based resin means a polymer in which L-form lactic acid and/or D-form lactic acid are the main constituting unit (monomer component). The polylactic acid-based resin used as the main component of the resin composition (A) may contain other copolymer components than lactic acid as a constituting unit of the polylactic acid-based resin, such other constituting units include glycol compounds such as ethylene glycol, propylene glycol, butane diol, heptane diol, hexane diol, octane diol, nonane diol, decane diol, 1,4-cyclohexane dimethanol, neopentyl glycol, glycerin, pentaerythritol, bisphenol A, polyethylene glycol, polypropylene glycol and polytetramethylene glycol; dicarboxylic acids such as oxalic acid, adipic acid, sebacic acid, azelaic acid, dodecane dioic acid, malonic acid, glutaric acid, cyclohexane dicarboxylic acid, terephthalic acid, isophthalic acid, phthalic acid, naphthalene dicarboxylic acid, bis(p-carboxyphenyl) methane, anthracene dicarboxylic acid, 4,4′-diphenyl ether dicarboxylic acid, 5-sodium sulfoisophthalate and 5-tetrabutyl phosphonium isophthalic acid; hydroxycarboxylic acids such as glycolic acid, hydroxypropionic acid, hydroxybutyric acid, hydroxyvaleric acid, hydroxycaproic acid and hydroxybenzoic acid: and lactones such as caprolactone, valerolactone, propiolactone, undecalactone, 1,5-oxepane-2-on.

The polylactic acid-based resin refers to a resin in which the lactic acid units account for 50 mol % or more and 100 mol % or less relative to the total constituting units in the polymer which is taken as 100 mol % but, in view of the extrusion characteristics, it is preferably 60 mol % or more and 100 mol % or less and still more preferably 80 mol % or more and 100 mol % or less.

For applications in which thermal resistance is required, it is preferable to use a polylactic acid-based resin whose optical purity of lactic acid unit is high, as the polylactic acid-based resin or the like which is the main component of the resin composition (A). That is, it is preferable that, in the total 100 mol % lactic acid units in the polylactic acid-based resin, L-form lactic acid units account for 80 mol % or more and 100 mol % or less or D-form lactic acid units account for 80 mol % or more and 100 mol % or less, and it is more preferable that L-form lactic acid units account for 90 mol % or more and 100 mol % or less or D-form lactic acid units account for 90 mol % or more and 100 mol % or less. It is still more preferable that L-form lactic acid units account for 95 mol % or more and 100 mol % or less or D-form lactic acid units account for 95 mol % or more and 100 mol % or less, and it is most preferable that L-form lactic acid units account for 98 mol % or more and 100 mol % or less or D-form lactic acid units account for 98 mol % or more and 100 mol % or less.

In addition, for applications in which thermal resistance is required, it is preferable to use polylactic acid stereocomplex as the polylactic acid-based resin or the like which is the main component of the resin composition (A). A method helpful for forming a polylactic acid stereocomplex is mixing, with a technique such as melt-kneading or solution mixing, a poly-L-lactic acid in which L-form lactic acid units account for 90 mol % or more and 100 mol % or less, preferably 95 mol % or more, and more preferably 98 mol % or more to form a more effective stereocomplex, of the total 100 mol % lactic acid units in the total polylactic acid-based resin, with a poly-D-lactic acid in which D-form lactic acid units account for 90 mol % or more and 100 mol % or less, preferably 95 mol % or more, and more preferably 98 mol % or more to form more effective stereocomplexes, of the total 100 mol % lactic acid units. Another method for forming a polylactic acid stereocomplex is to produce a block copolymer consisting of poly-L-lactic acid segments and poly-D-lactic acid segments. The use of a block copolymer consisting of poly-L-lactic acid segments and poly-D-lactic acid segments is preferable for easy formation of a polylactic acid stereocomplex. For this disclosure, a polylactic acid stereocomplex may be used alone or a polylactic acid stereocomplex may be used in combination with a poly-L-lactic acid or a poly-D-lactic acid. A poly-L-lactic acid and a poly-D-lactic acid refer to a resin in which 50 mol % or more of the total 100 mol % lactic acid units is accounted for by L-form lactic acid units or D-form lactic acid units, respectively.

For production of a polylactic acid-based resin, publicly known polymerization methods can be used, such as direct polymerization from lactic acid and ring-opening polymerization via a lactide.

The molecular weight and molecular weight distribution of the polylactic acid-based resin are not particularly limited as far as extrusion molding processing is substantially possible, but the weight average molecular weight is usually 10,000 to 500,000, preferably 40,000 to 300,000 and more preferably 80,000 to 250,000. The weight average molecular weight mentioned here means the molecular weight of the polymethyl methacrylate (PMMA) determined by gel permeation chromatography. When the weight average molecular weight is less than 10,000, the molded substance (laminated film) will be very brittle and often unsuitable for practical use. When the weight average molecular weight exceeds 500,000, the melt viscosity becomes too high, leading to difficulty in extrusion or surface roughness of the film.

The melting point of the polylactic acid-based resin is, in view of thermal resistance, preferably 120° C. or more, and more preferably 150° C. or more. The upper limit is not particularly limited, but it is 190° C. in most cases. An amorphous polylactic acid-based resin which shows no melting point can also be used, but in view of mechanical properties and gas barrier property of the laminated film, it is preferable to use a crystalline polylactic acid-based resin.

In addition, it is preferable for the resin composition (A) to contain, as a subcomponent, a polyolefin-based resin to improve the crystallinity or moisture barrier property and improve the interlayer adhesive strength between Layer A and Layer B. As the polyolefin-based resin which can be used as the sub-component of the resin composition (A), the same resin as the polyolefin-based resin which is preferably used as the resin layer (B) mentioned later, is preferable.

Furthermore, in the film formation process, it is preferable to re-use film scraps as recyclable material for Layer A (namely, the resin composition (A)) to achieve a reduction in cost for film production. In this case, Layer B (the resin composition (B)) and Layer C (the resin composition (C)) will be contained in Layer A (the resin composition (A)), and thus polyolefin-based resin or the like will be contained in Layer A (namely, the resin composition (A)) as sub-component.

The expression “the polylactic acid-based resin is the main component of the resin composition (A)” means that the polylactic acid-based resin account for the largest part of the total components of the resin composition (A) which constitutes Layer A. It is possible to add a sub-component up to a content less than that of the polylactic acid-based resin which is the main component of the resin composition (A). In view of stable film forming, in the resin composition (A) 100 wt %, the polylactic acid-based resin preferably account for 70 wt % or more and 100 wt % or less, and the sub-components such as biodegradable resins other than the polylactic acid-based resin, polyolefin-based resin and various additives preferably account for 0 wt % or more and 30 wt % or less.

To improve the compatibility between the polylactic acid-based resin which is the main component of the resin composition (A) and the sub-components such as polyolefin-based resin, it is also preferable to further add a compatibilizer as a sub-component to the resin composition (A). The preferred ones include a polyolefin-based resin containing a polar group, an acrylic resin containing a polar group, a styrene-based resin containing a polar group and a block copolymer of a polyolefin-based resin and a polystyrene-based resin containing a polar group.

If in the resin composition (A), polylactic acid-based resin is used as the main component, other biodegradable resin or polyolefin-based resin used as a sub-component and a compatibilizer used as another sub-component, to improve the thermal resistance, it is preferable to add the polylactic acid-based resin up to 56 wt % or more and 99 wt % or less, the sub-component such as other biodegradable resin or polyolefin-based resin up to 0.5 wt % or more and 24 wt % or less and the compatibilizer up to 0.5 wt % or more and 20 wt % or less relative to the total (100 wt %) resin composition (A).

It is important that the main component of the resin composition (B) is a polyolefin-based resin in view point of surface smoothness and, as the polyolefin-based resin, at least one selected from the group consisting of polypropylene, ethylene-propylene random copolymer, ethylene-propylene block copolymer, ethylene-propylene-butene random copolymer and propylene-butene random copolymer can preferably be used and, in the range in which the effect is not impaired, the above-mentioned polyolefin-based resins can be used alone or in combination with one or more of them. In particular, the polyolefin-based resin is preferably polypropylene used alone or a mixture of polypropylene with a ethylene-propylene random copolymer and/or ethylene-propylene block copolymer. In this case, the preferable content range of the ethylene component in the entire resin composition (B) is 0.1 to 10 wt %, more preferably 0.2 to 6 wt % and still more preferably 0.5 to 2 wt %. Addition of the ethylene component up to 0.1 wt % or more serves to improve the gas barrier property and if the content of the ethylene component is 10 wt % or less, the thermal resistance of the film can be maintained and it is advantageous in view of vapor deposition property or the like.

The expression “the polyolefin-based resin is the main component of the resin composition (B)” means that the polyolefin-based resin account for the largest part of the total components of the resin composition (B) which constitutes Layer B. Preferably, in the resin composition (B) (100 wt %), the polyolefin-based resin which is the main component accounts for 70 wt % or more and 100 wt % or less and the sub-component accounts for 0 wt % or more and 30 wt % or less. More preferably, the polyolefin-based resin accounts for 80 wt % or more and 100 wt % or less and the sub-component accounts for 0 wt % or more and 20 wt % or less. Still more preferably, the polyolefin-based resin accounts for 90 wt % or more and 100 wt % or less and the sub-component accounts for 0 wt % or more and 10 wt % or less. It is especially preferable that the polyolefin resin accounts for 100 wt %.

The production method of the polyolefin-based resin is not particularly limited and publicly known methods can be applied. For polypropylene-based resin, common methods such as radical polymerization, coordination polymerization in which Ziegler-Natta catalyst is used, anionic polymerization or coordination polymerization in which metallocene catalyst is used can be applied.

It is preferable that the polyolefin-based resin has a melt flow rate (MFR) of 1 to 100 g/10 min, more preferably 2 to 80 g/10 min, and still more preferably 4 to 60 g/10 min, as measured in accordance with JIS-K7210 (1999) under conditions of 230° C. and a load of 2.16 kg. Especially preferably it is 5 to 15 g/10 min and most preferably 8 to 13 g/10 min. If MFR is in the range of 1 to 100 g/10 min, the resin has an adequate crystallinity, and the dimensional stability, moisture resistance and surface smoothness of the laminated film are improved. Its ability for uniform lamination with Layer A, which is composed of the resin composition (A) whose main component is polylactic acid-based resin, is improved, making it possible to prevent a flow mark formation. If MFR is smaller than 1 g/10 min, the melt viscosity will be too high and extrusion properties will be easily impaired. If MFR exceeds 100 g/10 min, the crystallinity will be too high and, as a result, the film-forming property may be greatly impaired or mechanical properties may greatly deteriorate. The surface layer crystallization can proceed to an excessive degree to cause a rough surface, possibly leading to deterioration of printing accuracy or aggravation of gas barrier property after vapor deposition. In all descriptions below, the melt flow rate (MFR) means the value measured in accordance with JIS-K7210 (1999) under conditions of 230° C. and a load of 2.16 kg.

In addition, it is preferable that the intrinsic viscosity [η] of polyolefin-based resin is, in view of having an adequate crystallinity, 1.4 to 3.2 dl/g and more preferably 1.6 to 2.4 dl/g. If the [η] is smaller than 1.4 dl/g, the crystallinity will be too high, causing the film to become brittle causing the vapor deposition barrier property to deteriorate because of roughening of the surface. If it exceeds 3.2 dl/g, the crystallinity decreases significantly and the thermal resistance may deteriorate.

The main component of the resin composition (C) is not particularly limited, but polyolefin-based resin or polylactic acid-based resin can be preferably used as the main component of the resin composition (C). Specifically, such polyolefin-based resin is at least one selected from the group consisting of polypropylene, ethylene-propylene random copolymer, ethylene-propylene block copolymer, ethylene-propylene-butene random copolymer and propylene-butene random copolymer. As the polyolefin-based resin, exactly the same one as the polyolefin-based resin used in the resin composition (B) can also be used. In this case, a three layer constitution comprising two resins, i.e., polyolefin-based resin layer (Layer B)/layer A/polyolefin-based resin layer (Layer C), should be employed.

The main component in the resin composition (C) is defined as the resin that accounts for the largest part of the total components in the resin composition (C) which constitutes Layer C. Preferably, in the resin composition (C) 100 wt %, the polyolefin-based resin or the polylactic acid-based resin which is the main component accounts for 70 wt % or more and 100 wt % or less and the sub-component accounts for 0 wt % or more and 30 wt % or less. More preferably, the polyolefin-based resin or the polylactic acid-based resin which is the main component accounts for 80 wt % or more and 100 wt % or less and the sub-component accounts for contained 0 wt % or more and 20 wt % or less. Still more preferably, the polyolefin-based resin or the polylactic acid-based resin which is the main component accounts for 90 wt % or more and 100 wt % or less and the sub-component accounts for 0 wt % or more and 10 wt % or less. It is particularly preferable that the polyolefin-based resin or the polylactic acid-based resin which is the main component accounts for 100 wt %.

In addition, as the resin composition (C), either polyolefin-based resin or polylactic acid-based resin can preferably be used as the main component, but as the sub-component, it is possible to contain the other one of the two.

In the case where a polylactic acid-based resin is used as the main component of the resin composition (C) which constitutes Layer C, it is preferable to use a low melting point polylactic acid-based resin or an amorphous polylactic acid-based resin whose crystallinity is lower than that of the polylactic acid-based resin used in Layer A which is the main layer to develop heat sealability. An amorphous D-form copolymerized L-polylactic acid or the like which can make close contact with Layer A is preferably used. Heat sealability is necessary to produce a bag from the film that is to be filled and sealed, and adhesion is achieved by thermal melting and press-bonding of the adhesive layer. It is preferable that Layer C has heat sealability in view of cost reduction or environmental load relief since it serves to simplify the production processes and reduce the film thickness, compared to providing a heat seal layer by extrusion lamination or providing a heat seal layer by dry lamination.

In the case where a polyolefin-based resin is used as Layer C, it is also preferable that Layer C has heat sealability, and as polyolefin-based resin that is heat-sealable and excellent in low temperature and high speed sealing property, ethylene-propylene random copolymers, ethylene-propylene-butene random copolymers and propylene-butene random copolymers are preferably used. It is possible to develop heat sealability by using, as the resin composition (C), a low melting point polyolefin-based resin or an amorphous polyolefin-based resin whose crystallinity is lower than that of the resin composition (A).

To improve the interlayer adhesive strength between Layer A and Layer B or between Layer A and Layer C, it is also preferable that Layer A and Layer B and/or Layer A and Layer C are laminated via a layer of an adhesive resin (D). The adhesive resin (D) is a resin capable of being co-extruded or co-drawn. Materials useful as the adhesive resin (D) include ethylene/vinyl acetate copolymers, ethylene/(meth)acrylic acid ester copolymers, polyolefin-based resin containing a polar group, acrylic resin containing a polar group, styrene-based resin containing a polar group, block copolymers of spolyolefin-based resin and polystyrene-based resin containing a polar group, and the like.

It is preferable that the MFR of the adhesive resin (D) is 1 to 50 g/10 min, more preferably 5 to 35 g/10 min and still more preferably 8 to 20 g/10 min. When the MFR is in the range of 1 to 50 g/10 min, extrusion stability of the resin alone is high. The MFR is the value determined in accordance with JIS-K7210 (1999) under conditions of 230° C. and a load of 2.16 kg.

For the adhesive resin (D), the 5% heat-loss temperature determined by thermogravimetry is preferably 230° C. or more, more preferably 240° C. or more, to achieve an appropriate extrusion stability.

In the case where an ethylene/vinyl acetate copolymer is used as the adhesive resin (D), it is preferable that the vinyl acetate component content accounts for 25 wt % or more and less than 55 wt % of the total (100 wt %) amount of the ethylene/vinyl acetate copolymer. The remaining component in the ethylene/vinyl acetate copolymer after taking off the vinyl acetate component is the ethylene component. It is more preferable that the vinyl acetate component content is in the range of 28 wt % to 50 wt %, more preferably 30 wt % to 45 wt %, and still more preferably 34 wt % to 41 wt %, of the total (100 wt %) amount of the ethylene/vinyl acetate copolymer.

In the case where an ethylene/(meth)acrylic acid ester copolymer is used as the adhesive resin (D), it is preferable that the (meth)acrylic acid ester component content is 30 wt % or more, more preferably in the range of 30 wt % to 50 wt %, of the total (100 wt %) amount of the ethylene/(meth)acrylic acid ester copolymer. The remaining component in the ethylene/(meth)acrylic acid ester copolymer after taking off the (meth)acrylic acid ester component is the ethylene component.

To produce polyolefin-based resin containing a polar group, acrylic resin containing a polar group, styrene-based resin containing a polar group or block copolymers of polyolefin-based resin and polystyrene-based resin containing a polar group, it is preferable to use at least one functional group selected from the group consisting of acid anhydride group, amino group, imino group and epoxy group, more preferably at least one functional group selected from the group consisting of acid anhydride group and epoxy group, as the polar group to be introduced. Among them, since maleic anhydride graft copolymerized polyolefin resin is excellent in adhesive properties especially with Layer A, it can preferably be used as the layer D.

In the case where the maleic anhydride graft copolymerized polyolefin-based resin is used, it is preferable that the modification ratio of the maleic anhydride is 0.05 to 4.0 wt %, more preferably 0.1 to 3.0 wt %, and still more preferably 0.2 to 2.5 wt %, in the total (100 wt %) amount of the maleic anhydride graft copolymerized polyolefin-based resin. When the modification ratio is in such a range, the resin will be excellent in the stability during single-component extrusion and adhesiveness. Commercial products of the adhesive resin (D) include Admer (trademark) produced by Mitsui Chemicals, Inc., Orevac (trademark), and Lotader (trademark) produced by Arkema Inc.

In the layer D, the adhesive resin (D) is the main component, and preferably, the adhesive resin (D) accounts for 70 wt % or more and 100 wt % or less in the total (100 wt %) component of the layer D. The layer D can contain a sub-component such as additives, as required, unless it has adverse effect on the adhesive resin (D).

Improvement in the interlayer adhesion between Layer A and Layer B or between Layer A and Layer C can also be achieved by way of adding an adhesive resin (E) to at least one of the resin composition (A), the resin composition (B) and the resin composition (C). This method is preferable because a layer composed of the adhesive resin (D) is not required and the number of layers in the laminated film can be decreased, leading to a simplified lamination process.

As the adhesive resin (E), polyolefin-based resin containing at least one functional group selected from the group consisting of acid anhydride group, amino group, imino group and epoxy group is preferable, and polyolefin-based resin containing at least one functional group selected from the group consisting of acid anhydride group and epoxy group is more preferable. In particular, maleic anhydride graft copolymerized polyolefin-based resin is preferably used.

In the maleic anhydride graft copolymerized polyolefin-based resin which is the adhesive resin (E), it is preferable that modification ratio of maleic anhydride is 0.05 to 10.0 wt %, more preferably 0.1 to 8.0 wt % and still more preferably 0.5 to 6.0 wt % relative to the total (100 wt %) amount of the maleic anhydride graft copolymerized polyolefin-based resin. A modification ratio in the range of 0.05 to 10.0 wt % is preferable in view of compatibility between a sufficient interlayer adhesion and extrusion stability. When the modification ratio of the maleic anhydride graft copolymerized polyolefin-based resin which is the adhesive resin (E) is higher than 10.0 wt %, the thermal resistance of the adhesive resin (E) becomes insufficient, and when the maleic anhydride graft copolymerized polyolefin-based resin which is the adhesive resin (E) is contained in any of the resin composition (A), the resin composition (B) and the resin composition (C) and extruded, a gelation or decomposition may occur. When the modification ratio of the maleic anhydride graft copolymerized polyolefin-based resin which is the adhesive resin (E) is less than 0.05 wt %, the interlayer adhesion properties may not be developed even if such an adhesive resin (E) is added to any of the resin composition (A), the resin composition (B) and the resin composition (C).

The content of the adhesive resin (E) is preferably 0.1 to 15 wt %, more preferably 0.5 to 10 wt, in the 100 wt % amount of each of the resin composition (A), the resin composition (B) and the resin composition (C) that contain the adhesive resin (E). When the content of the adhesive resin (E) is in the range of 0.1 to 15 wt % in the 100 wt % amount of the resin composition, the interlayer adhesion will be maintained without deterioration in the mechanical properties, gas barrier property, thermal stability and the like of the laminated film.

It is preferable that the weight average molecular weight of the maleic anhydride graft copolymerized polyolefin-based resin which is suitable as the adhesive resin (E) is 1,000 to 50,000, more preferably 3,000 to 40,000. Regarding the maleic anhydride graft copolymerized polyolefin-based resin, in view of extrusion stability, it is preferable that the 5% heat-loss temperature determined by thermogravimetry is 230° C. or more, more preferably 240° C. or more.

Major commercial products for the adhesive resin (E) include Umex (trademark) produced by Sanyo Chemical Industries, and DP Adhesive Resin produced by DuPont and the like.

In the case where biodegradability of the film is taken account of, it is preferable that biodegradable resin is contained in the resin composition (B) and/or the resin composition (C). Such biodegradable resins include polylactic acid, polyglycolic acid, poly-3-hydroxybutylate, poly-3-hydroxybutylate-3-hydroxyvalerate, polycaprolactone; and aliphatic polyesters obtainable from aliphatic diols such as ethylene glycol and 1,4-butane diol and aliphatic dicarboxylic acids such as succinic acid and adipic acid; and copolymers of aliphatic polyester and aromatic polyester such as polybutylene succinate/terephthalate and polybutylene adipate/terephthalate; and polyvinyl alcohol.

It is preferable that the content of the biodegradable resin is 1 to 50 wt % relative to the 100 wt % amount of each resin composition, i.e., the resin composition (B) or the resin composition (C). It is more preferably 2 to 30 wt % and still more preferably 3 to 20 wt %. If it exceeds 50 wt %, the film-forming property and water vapor transmission are aggravated. If it is less than 1 wt %, biodegradability becomes difficult to develop.

In the case where biodegradable resin is contained in the resin composition (B) or in the resin composition (C), it is preferable that a dispersant is further contained to finely disperse the biodegradable resin in the resin composition. In the case where the resin composition (B) or the resin composition (C) contains polyolefin-based resin and the above-mentioned biodegradable resin, the preferable dispersants to be contained in the resin composition (B) or in the resin composition (C) include (1) ethylene/vinyl acetate copolymer, (2) ethylene/acrylic acid ester copolymer, ethylene/methacrylic acid ester copolymer, (3) polyolefin-based resin containing at least one kind of functional group selected from the group consisting of acid anhydride group, carboxyl group, amino group, imino group, alkoxysilyl group, silanol group, silyl ether group, hydroxyl group and epoxy group, (4) acrylic resin or styrene resin containing at least one kind of functional group selected from the group consisting of acid anhydride group, carboxyl group, amino group, imino group, alkoxysilyl group, silanol group, silyl ether group, hydroxyl group and epoxy group, and, (5) polyolefin-polystyrene block copolymer containing at least one kind of functional group selected from the group consisting of acid anhydride group, carboxyl group, amino group, imino group, alkoxysilyl group, silanol group, silyl ether group, hydroxyl group and epoxy group. Of these, the polyolefin-polystyrene block copolymer in the group (5) is preferred.

It is preferable that the content of the dispersant is 0.1 to 20 wt % in the 100 wt % amount of each resin composition that constitutes the resin composition (B) or the resin composition (C). It is more preferably 0.5 to 15 wt % and still more preferably 1 to 10 wt %. If it exceeds 20 wt %, the film-forming property will be aggravated. If it is less than 0.1 wt %, the dispersing effect will be decreased.

It is preferable that at least one layer selected from the group consisting of the resin composition (A), the resin composition (B) and the resin composition (C) contains a drawing auxiliary, in view of improvement of productivity by increasing the draw ratio and preventing breakage, and improvement of surface smoothness.

As the drawing auxiliary to be contained in the resin composition (A) whose main component is the polylactic acid-based resin, a polyester, a block copolymer of polyester and polylactic acid, a block copolymer of polyether and polylactic acid, a polyolefin acrylate or the like are preferably used.

Preferable polyesters that function as drawing auxiliary include aromatic and/or aliphatic polyester such as polybutylene terephthalate, polypropylene terephthalate, polybutylene sebacate, polybutylene succinate, polybutylene succinate/terephthalate, polybutylene adipate/terephthalate, polybutylene succinate/adipate, polypropylene sebacate, polypropylene succinate, polypropylene succinate/terephthalate, polypropylene adipate/terephthalate, or polypropylene succinate/adipate. Among them, polybutylene adipate/terephthalate and polybutylene succinate/adipate are especially effective in improving drawability.

In view point of the compatibility with polylactic acid-based resin, it is preferable that the weight average molecular weight of the drawing auxiliary, such as a polyester, a block copolymer of polyester and polylactic acid or a block copolymer of polyether and polylactic acid, is 2,000 to 200,000, more preferably 5,000 to 150,000 and especially preferably 10,000 to 100,000. The weight average molecular weight mentioned here is the molecular weight measured by gel permeation chromatography (GPC) in chloroform solvent and calculated with polymethyl methacrylate method.

In addition, the block copolymer of polyester and polylactic acid or the block copolymer of polyether and polylactic acid are a block copolymer of polyester segment or polyether segment with polylactic acid segment. It is preferable that the content of the polylactic acid segment is 60 wt % or less relative to the total (100 wt %) amount of the block copolymer of polyester or polyether and polylactic acid. In the block copolymer of polyester and polylactic acid or in the block copolymer of polyether and polylactic acid, the effect of improving drawability may become poor if the content of polylactic acid segment exceeds 60 wt %. In view of preventing bleed out, it is preferable that one or more polylactic acid segment whose weight average molecular weight is 1,500 or more is contained in each molecule of the block copolymer. The polylactic acid segment acts to increase the compatibility with the resin composition (A) whose main component is the polylactic acid-based resin.

As the polyester segment in the above-mentioned block copolymer of polyester and polylactic acid, polybutylene terephthalate, polypropylene terephthalate, polybutylene sebacate, polybutylene succinate, polybutylene succinate/terephthalate, polybutylene adipate/terephthalate, polybutylene adipate/succinate, polypropylene sebacate, polypropylene succinate, polypropylene succinate/terephthalate, polypropylene adipate/terephthalate, polypropylene adipate/succinate and the like are preferably used.

As the polyether segment in the above-mentioned block copolymer of polyether and polylactic acid, polyethylene glycol, polypropylene glycol, polytetramethylene glycol, polyethylene glycol, polypropylene glycol copolymer and the like are preferably used.

It is preferable that the content of the drawing auxiliary is 0.1 to 20 wt % relative to the total (100 wt %) resin composition (A). The content is more preferably 0.2 to 10 wt % and still more preferably 0.5 to 5 wt %.

These explanations also apply to cases where the drawing auxiliary is contained in the resin composition (C) whose main component is polylactic acid-based resin, and it is preferable that the above-mentioned drawing auxiliary accounts for contained 0.1 to 20 wt %, more preferably 0.2 to 10 wt % and still more preferably 0.5 to 5 wt % relative the total (100 wt %) resin composition (C) whose main component is polylactic acid-based resin.

The resin composition (A) whose main component is polylactic acid-based resin preferably contains polyglycolic acid, poly-3-hydroxybutylate, poly-3-hydroxybutylate-3-hydroxyvalerate or polycaprolactone which is biodegradable resin, aliphatic polyester constituted with aliphatic diol such as ethylene glycol or 1,4-butane diol and aliphatic dicarboxylic acid such as succinic acid or adipic acid, furthermore, copolymer of aliphatic polyester and aromatic polyester such as polybutylene succinate/terephthalate or polybutylene adipate/terephthalate, polyvinyl alcohol or the like to control the film rigidity and control the biodegradation rate. This applies also to cases where the resin composition (C) whose main component is polylactic acid-based resin is used.

In view of the improvement of toughness, gas barrier property and drawability, the preferable drawing auxiliaries to be incorporated in the resin composition (B) whose main component is polyolefin-based resin include a hydrocarbon resin having substantially no polar group and/or a terpene resin having substantially no polar group. The hydrocarbon resin having substantially no polar group is a hydrocarbon resin which has no polar group consisting of hydroxyl group, carboxyl group, halogen group, sulfonic group or degenerated substance thereof or the like, and specifically, it is a cyclopentadiene-based resin whose raw material is petroleum-based unsaturated hydrocarbon or a resin whose main raw material is a higher olefin-based hydrocarbon.

Furthermore, it is preferable that the glass transition point temperature of such hydrocarbon resin having substantially no polar group is 60° C. or more. If the glass transition temperature is lower than 60° C., the rigidity enhancement effect can deteriorate.

In addition, a hydrogenated (hereafter, occasionally abbreviated as “suiten”) hydrocarbon resin, obtained by hydrogenating such hydrocarbon resin having no polar group to increase its hydrogenation ratio to 90% or more, preferably 99% or more, is especially preferred. Major hydrogenated hydrocarbon resins include alicyclic hydrocarbon resin such as polydicyclopentadiene whose glass transition temperature is 70° C. or more and hydrogenation ratio is 99% or more.

In addition, the terpene resin having substantially no polar group is a terpene resin having no polar group consisting of hydroxyl group, aldehyde group, ketone group, carboxyl group, halogen group or sulfonic group, modified substances thereof or the like. Specially, they are hydrocarbons in the form of (C₅H₈)ₙ and modified compounds derived therefrom, wherein n is a natural number of about 2 to 20.

The terpene resin is also referred to as terpenoid and typical compounds include pinene, dipentene, carene, myrcene, ocimene, limonene, terpinolene, terpinene, sabinene, tricyclene, bisabolene, zingiberene, santalene, camphorene, mirene, and totaren. For the biaxially drawn polypropylene film used as the base layer, it is preferable to add hydrogen up to a hydrogenation rate of 90% or more, more preferably 99% or more. Among them, hydrogenated β-pinene, hydrogenated β-dipentene and the like are especially preferred.

It is preferable that the content of such a drawing auxiliary is 0.1 to 30 wt % relative to the total (100 wt %) resin composition (B). When the content of drawing auxiliary is less than 0.1 wt %, the drawability improving effect may deteriorate, or the transparency may deteriorate. When it exceeds 30 wt %, the thermal dimensional stability of the film may be aggravated and the auxiliary may bleed out on the film surface layer to impair slipperiness. Furthermore, the film may cause blocking with each other, or vapor deposition gas barrier property or printing accuracy of the film may be aggravated.

The use of a hydrocarbon resin and/or a terpene resin containing a polar group is not preferred since it is inferior in compatibility with the polyolefin-based resin which is the main component of the resin composition (B), and voids are easy formed inside the film, leading to the possibility of a deterioration of gas barrier property and a bleed-out of other additives.

Major commercial products of preferable drawing auxiliaries to be contained in the resin composition (B) include Escoretz produced by Tonen Chemical Corp., Clearon produced by Yasuhara Chemical Co., Alcon produced by Arakawa Chemical Industries, and Aimarb produced by Idemitsu Kosan Co.

These explanations apply also to cases where drawing auxiliary is incorporated into the resin composition (C) whose main component is polyolefin-based resin.

As long as the effect is not impaired, an antiblocking agent, a stabilizer (antioxidant, ultraviolet absorber or the like), a lubricant (alkyl carboxylic acid amide, stearic acid salt or the like), an antistatic agent (alkyl sulfonic acid salt, alkyl aliphatic acid salt, alkyl aliphatic acid ester or the like), a colorant including dye and pigment, a nucleating agent or the like can be added to the resin compositions which constitute the respective layers.

A antiblocking agent consists of particles to be added to the resin in the surface layer for the purpose of imparting unevenness on the film surface to improve handling property of the film by preventing blocking of the film with each other. Preferable materials include inert particles such as agglomerated silica, colloidal silica, alumino-silicate, cross-linked PMMA, cross-linked polystyrene or calcium carbonate, of which agglomerated silica, colloidal silica and alumino-silicate are particularly preferable.

As the antistatic agent, publicly known cationic, anionic, amphoteric and nonionic ones can be used, and common methods such as applying them on the film surface and kneading them with the resin component can be employed. However, in the case where they are kneaded with the resin component, the use of an ionic antistatic agent is not preferable since the polylactic acid-based resin component can decompose during kneading, and therefore a nonionic antistatic agent is preferably used in such a case. As the nonionic antistatic agent, (poly)ethylene glycol, (poly)propylene glycol, glycerin, polyhydric alcohols such as sorbitol and/or their aliphatic acid esters or the like are preferable.

Production methods of the laminated film are explained below.

The resin compositions (A), (B) and (C) used to constitute the layers A, Layer B and Layer C are fed to respective extruders, and subjected to removal of foreign materials and adjustment for uniform extrusion rates through filters and gear pumps in their respective channels. Then the resin compositions (A), (B) and (C) that constitute Layers A, B and C, respectively, are joined and laminated in a multi-layer lamination die or in a short pipe in the feed block or manifold provided at the upper portion of the die, extruded into a sheet from the die, brought into close contact with a casting drum with an air knife, by electrostatic charging or the like, and solidified by cooling to produce an undrawn film in which Layer B, Layer A and Layer C are laminated in this order. Then, the sheet is pre-heated between rolls, subsequently drawn in the longitudinal direction by passing between rolls with differential peripheral speeds, and immediately cooled to room temperature. Subsequently the drawn film is introduced into a tenter and drawn, and then heat-fixed while relaxing in the width direction and wound. Or, it may be drawn in the longitudinal direction and in the width direction simultaneously, or may be subjected to repeated operations of drawing in the longitudinal direction and in the width direction.

It is preferable that drawing of the laminated film is performed through a “drawing process under polylactic acid-based resin conditions” in view of the mechanical properties of film. That is, it is preferable to control the longitudinal drawing temperature at 75 to 85° C., more preferably 80° C. to 85° C. and up to a preferable draw ratio of 2.5 to 4.2. It is preferable to control the transverse drawing temperature at 70 to 90° C., more preferably 75 to 80° C., and it is preferable that the draw ratio is 2.5 to 4.0.

If a drawing auxiliary as mentioned above is used in any of layers of the laminated film, it is possible to broaden the temperature and drawing conditions for the “drawing process under polylactic acid-based resin conditions.” For example, if a drawing auxiliary is added to the resin composition (A), it is preferable that the longitudinal drawing temperature is 60 to 85° C., and it is preferable that the draw ratio is 3.0 to 5.0, in view of the mechanical properties of the film. Furthermore, it is preferable that the transverse drawing temperature is 70 to 100° C. and, it is preferable that the draw ratio is 2.5 to 10.0.

In addition, to prevent thermal shrinkage of the film after drawing, the temperature used for heat fixation or relaxation is preferably 120 to 150° C., more preferably 125 to 145° C. and still more preferably 130 to 140° C. The relaxation ratio is preferably 2 to 15%, more preferably 5 to 10% and still more preferably 8 to 10%. After that, it is cooled.

On the other hand, a “drawing process under polyolefin-based resin conditions” is preferable in view of productivity and improvement of stability during film processing. That is, it is preferable to control the longitudinal drawing temperature at 125 to 145° C., more preferably 130 to 145° C., and it is preferable that the draw ratio is 3.5 to 7.0 times. It is preferable to the control the transverse drawing temperature at 140 to 170° C., more preferably 150 to 165° C., and it is preferable that the draw ratio is 5 to 10 times. To prevent thermal shrinkage of the film after drawing, the temperature used for heat fixation or relaxation is preferably 155 to 170° C., and the relaxation ratio is preferably 2 to 15%, more preferably 5 to 10% and still more preferably 8 to 10%. After that, it is cooled.

The areal draw ratio, which is expressed as a product of the draw ratios in the longitudinal and width directions, is preferably 20 to 70 in view of productivity, unevenness in thickness, surface smoothness and mechanical strength of the film. It is more preferably 25 to 50 times. The use of a drawing auxiliary as mentioned above in any layer in the laminated film can serve to increase the draw ratio. For example, if a drawing auxiliary is added to the resin composition (B), it is preferable that the draw ratio in the longitudinal direction is 3.0 to 6.0 and the draw ratio in the width direction is 5.0 to 12.0. This is preferable to improve the surface smoothness of Layer B as mentioned above.

Thus, the laminated film can be produced under considerably different conditions (specifically, the drawing under the “polyolefin-based resin conditions” and “polylactic acid-based resin conditions” mentioned above) depending on whether the film forming conditions are designed for improvement of mechanical properties or the film forming conditions are designed for improvement of productivity or stability during film processing. This is a feature found in our films. That is, although ordinary resin film can be produced only under considerably limited conditions, our laminated films can be produced in a very wide range of film production conditions made possible by the use of a laminated film consisting of a layer composed of the resin composition (A) whose main component is polylactic acid-based resin (Layer A), a layer composed of the resin composition (B) whose main component is polyolefin-based resin (Layer B) and a layer composed of the resin composition (C) (layer C), in which Layer B, Layer A and Layer C are laminated in this order. This leads to the advantage that the film forming is possible by using existing production plants.

The film can be used more effectively if a gas barrier layer is provided. Such a gas barrier layer can be provided by coating, vapor deposition, lamination or the like, but a vapor deposited layer consisting of a metal or a metal oxide is more preferable because it is free of humidity dependency and can exhibit an excellent barrier property even if it is thin. It is preferable that such a gas barrier layer is provided to the side of Layer B in the laminated film. More preferably, the gas barrier layer is provided on the surface of Layer B where the center-line average roughness Ra is controlled at 10 to 85 nm.

It is preferable that the metal or metal oxide used for the vapor deposited layer is a metal or a metal oxide of aluminum, aluminium oxide, silicon oxide, cerium oxide, calcium oxide, diamond-like carbon film, or a mixture thereof. In particular, vapor deposition of aluminum or metal oxide of aluminum is more preferable since they are small in cost and good in gas barrier property.

In addition, as preparation methods for a vapor deposited layer on a thin film, various physical vapor deposition methods are available, such as vacuum vapor deposition method, EB vapor deposition method, sputtering method, ion plating method, various chemical vapor deposition methods such as plasma CVD or the like but, in view of productivity, vacuum vapor deposition is especially preferred.

When providing a vapor deposited layer, it is preferable to carry out beforehand pre-treatment with techniques such as corona discharge for the surface to be vapor-deposited to improve the contact of the vapor deposited layer. It is preferable that processing intensity for carrying out corona treatment is 5 to 50 W·min/m², more preferably 10 to 45 W·min/m². It is preferable that the atmosphere for corona treatment is not only air, but also it is preferably nitrogen, mixed gas of carbon dioxide/nitrogen, or the like, in view of improvement of contact with the vapor deposited layer. Furthermore, surface treatment such as gas treatment, plasma treatment, alkali treatment or electron beam radiation treatment may be carried out as required.

Since gas barrier property is better if the vapor deposited surface is smooth, the surface should be designed to be smooth. The above-mentioned additives such as antiblocking agent and stabilizer can bleed out to the film surface to generate vapor deposition defects and cause a decrease in barrier property in some cases and, therefore, it is important to appropriately control their content.

In addition, higher gas barrier property can be obtained by providing a coating layer in combination the vapor deposited layer. Thus, if an anchor coating agent is applied by an in-line or off-line process beforehand on Layer B of the laminated film to form a coating layer, the vapor deposited layer formed on the coating layer can achieve very close contact, effectively improving the gas barrier property. If an overcoating agent is applied over the vapor deposited layer, it serves to decrease defects in the vapor deposited layer and brings about improvement of gas barrier property. Preferable materials for such a coating layer include polyvinylidene chloride, polyvinyl alcohol, polyethylene-vinyl alcohol, acryl, polyester, polyurethane and polyester-polyurethane-based resin. The coating layer can contain various sub-components as long as they do not spoil the effects of the layer. The thickness of the coating layer is not particularly limited, but it is preferably 0.01 μm to 3 μm.

As a practical material for wrapping film, it is preferable that the laminated film has water vapor barrier property is less than 40 g/m²·day, more preferably less than 20 g/m²·day. The lower limit of the water vapor barrier property of the laminated film should be as low as possible. But practically, it is impossible to decrease it to less than 0.1 g/m²·day, and a value of about 0.1 g/m²·day is sufficient as material for wrapping film. Thus, the practical lower limit is considered to be about 0.1 g/m²·day.

It is preferable that the water vapor barrier property of the laminated film having the vapor deposited layer consisting of a metal or a metal oxide is less than 2.0 g/m² day, and it is more preferable to be less than 1.0 g/m²·day. The lower limit is preferably as small as possible but, practically, it is impossible to decrease it to less than 0.1 g/m²·day, and a value of about 0.1 g/m²·day is sufficient as material for wrapping film. Thus, the practical lower limit is considered to be about 0.1 g/m²·day.

It is preferable that the oxygen barrier property of the laminated film having a vapor deposited layer consisting of a metal or a metal oxide is less than 40 cc/m²·day atm, and it is more preferably less than 1.0 g/m²·day. The lower limit is preferably as small as possible but, practically, it is impossible to decrease it to less than 0.01 cc/m²·day, and a value of about 0.01 cc/m²·day is sufficient as material for wrapping film. Thus, the practical lower limit is considered to be about 0.01 cc/m²·day.

The thickness of the laminated film is not particularly limited, but it is preferably 1 to 500 μm, more preferably 3 to 100 μm and still more preferably 5 to 50 μm. The thickness of the respective layers is not particularly limited, but it is preferable that Layer A accounts for 30% or more of the entire thickness. It is preferable that each of Layer B, Layer C and the layer D does not exceed the thickness of Layer A. Concretely, it is preferable that Layer A accounts for 30 to 98%, and Layer B, Layer C and the layer D account for 0.5 to 30%, respectively, relative to the entire thickness of the laminated film.

Uses of the laminated film are not particularly limited, but it can be used effectively as a wrapping material. Accordingly, packaging material containing the laminated film in its constitution is a preferable application. For example, it can be used for wrapping bag or the like of a constitution in which a printing layer, the barrier layer (laminated film) and a heat seal layer are laminated in this order.

### EXAMPLES

Our films and methods are explained in detail with reference to Examples and Comparative Examples.

Measurements and evaluations of the respective physical properties and characteristics were made with the following techniques.

### [Melt Flow Rate (MFR)]

It was measured in accordance with JIS-K-7210 (1999) under the conditions of 230° C. under a load of 2.16 kg.

### [Film-Forming Property]

As film was produced, 300 m film samples were taken. They were evaluated as ◯ (good) if they were produced stably, Δ (fair) if surface roughness was visually found, and x (poor) if breakage took place frequently.

### [Film Thickness]

It was measured in accordance with JIS-B-7509 (1955) using a dial gauge type thickness tester.

### [Modulus]

It was measured in accordance with ASTM D882-64T (2002). Five measurements were made in the longitudinal direction and their average value was taken as the modulus in the longitudinal direction. The same procedure was carried out for the width direction.

### [Ratio of Modulus]

Using the values of the modulus determined with the above-mentioned measuring method, the ratio of the modulus in the longitudinal direction to the modulus in the width direction was calculated.

### [Thermal Shrinkage]

In accordance with JIS-Z-1712 (1997), shrinkage in the longitudinal direction after being subjected to heat treatment at 100° C. for 5 minutes and shrinkage in the longitudinal direction after being subjected to heat treatment at 120° C. for 15 minutes were determined. Five measurements were made and their average was taken as the respective shrinkage. The same procedure was carried out for the width direction.

### [Center-Line Average Roughness (Ra)]

In accordance with JIS B0601 (1976), it was measured for the film surface of Layer B by using a stylus type surface roughness tester (high precision thin-film-surface-roughness measuring instrument, model ET30HK, produced by Kosaka Laboratory Ltd.). The conditions used for this include a stylus diameter of 0.5 μm R (cone type), a load of 16 mg and a cut off of 0.08 mm. From the roughness curve, a part corresponding to a measured length of L is taken out in the center line direction. Assuming that the center line of the portion taken out forms the X-axis with the Y-axis being in the vertical direction and that the roughness curve is expressed as y=f(X), the value (μm) determined by the following equation is taken as the center-line average surface roughness Ra:

Ra=(1/L)∫|f(X)|dx.

For a single sample, five measurements were made for different positions and the average value obtained was taken as Ra.

### [Interlayer Adhesion]

After carrying out corona treatment on Layer B, a polyurethane-based adhesive (Takelac 971 (produced by Mitsui Chemicals Polyurethanes, Inc.)/Takenate A3 (produced by Mitsui Chemicals Polyurethanes, Inc.)/ethyl acetate (9:1:10)) was applied on Layer B, and attached to a corona-treated surface of a biaxially oriented polypropylene film of 20 μm thickness, followed by aging at 40° C. for 48 hours to obtain a composite film. For the film, a Tensilon manufactured by Toyo Baldwin Co. was used to measure the load required for peeling under the following conditions. The peeling resistance was evaluated in 5 grades and the peeled surface was inspected visually.

<Peeling Conditions>
Film width: 25.4 mm
Peel rate: 100 mm/min.
Peel angle: 90°

<Evaluation>
Peel load is less than 10 g: 1
10 g or more and less than 30 g: 2
30 g or more and less than 50 g: 3
50 g or more and less than 100 g: 4
100 g or more or film breakage: 5

<Peeled Surface>
Delamination in laminated film: a
Separation between polypropylene film and laminated film: b
Film breakage: c

### [Heat Sealing Property]

Layer C of laminated film of 15 mm width was heat sealed with another Layer C under the following conditions. Samples were evaluated as “heat sealable” (HS) if separable by hand or as “not heat sealable” (not HS) if unseparable by hand.

<Heat Sealing Conditions>
Pressure: 2 kg/cm², temperature: 140° C., time: 1 sec, seal width: 10 mm

### [Biodegradability]

Samples were composted in accordance with the test procedure of JIS K6953 (2000), and they were evaluated as “biodegradable” (BD) if their biodegradation rate was 60% or more after 8 weeks or as “not biodegradable” (not BD) if it was less than 60%.

### [Processability]

### (1) Vapor Deposition Property

In an atmosphere of mixed gas of nitrogen and carbon dioxide (carbon dioxide concentration 15 vol %), the film temperature was maintained at 60° C. and corona discharge treatment was carried out on the surface of Layer B at 30 W·min/m², followed by winding the film.

A film roll was set in a vacuum vapor deposition apparatus equipped with a film conveying device and after making a high vacuum of 1.00×10⁻² Pa, the film was conveyed on a cooling metal drum of 20° C. while forming a vapor-deposited thin film layer by heating and evaporating aluminum metal, followed by adjusting to an optical density of 2.5.

After vapor deposition, the inside pressure in the vacuum vapor deposition apparatus was returned to normal, and the wound film was rewound and aged at a temperature of 40° C. for 2 days to obtain a laminated film (vapor-deposited film) having a vapor-deposited layer.

The film was evaluated as ⊚ (excellent) if vapor-deposited especially uniformly, ◯ (good) if vapor-deposited uniformly, Δ (fair) if containing wrinkles, or x (poor) if suffering breakage during vapor deposition.

### (2) Printing Property

On the corona discharge treated film prepared in the above paragraph (1) “Vapor deposition property,” printing was carried out with a desk top printing tester K-Printing Proofer produced by RK Print-coat Instrument Ltd. (plate type: standard plate type D (color density: 60 to 100%/cell depth: 24 to 40 μm); ink: New fine 523 vermilion produced by Toyo Ink MFG Co.) on the surface of Layer B. after drying at 60° C. for 30 seconds, the halftone in the print was inspected with a microscope at a magnification of 50×.

The film was evaluated as ⊚ (excellent) if printed especially clearly, ◯ (good) if printed clearly, Δ (fair) if printed less clearly, and x (poor) if printed poorly.

### [Optical Density (OD)]

An optical density meter (TR927 produced by GretagMacbeth Co.) was used and calculations were made with the following equation:

OD is expressed as the common logarithm of the reciprocal of the transmittance, i.e., the ratio of the incident light I0 to the transmitted light passed through a sample.

OD=log(I0/I)

### [Water Vapor Transmission]

It was measured under the conditions of a temperature of 40° C. and a humidity of 90% RH using a water vapor transmission measuring instrument (Permatran (trademark) W3/31) produced by Mocon Co. in the U.S. in accordance with the B method (infra-red sensor method) described in JIS K7129 (2000). The measurement was carried out twice for each sample and the average was taken as its water vapor transmission. The evaluation was carried out for raw film and vapor-deposited film. Each film sample was set so that the surface of Layer B was exposed to the carrier gas using Layer A as reference.

### [Oxygen Transmission]

It was measured under the conditions of a temperature of 23° C. and a humidity of 0% RH using an oxygen transmission measuring instrument (Oxtran (trademark) 2/20) produced by Mocon Co. in the U.S. in accordance with the B method (equal pressure method) described in JIS K7126 (2000). The measurement was carried out twice for each sample and the average was taken as its oxygen transmission. The evaluation was carried out for vapor-deposited film. Each was set so that the surface of Layer B was exposed to the carrier gas using Layer A as reference.

### [Lamination Ratio]

Film samples were embedded in epoxy resin and ultra-thin sections were prepared by cutting with a microtome to observe a cross section in the longitudinal-thickness direction. Using these thin film sections of the film, cross-sectional photos of the film were taken at a magnification of 20,000× with a transmission electron microscope to determine the thickness of each layer in the width center of the film.

### [Raw Materials]

The raw materials used were as follows:
Polylactic acid-based resin (1) (abbreviated in the tables as PLA(1)) (D-form 1.2%, Mw (in terms of PMMA) 160,000, melting point 168° C.)
Polylactic acid-based resin (2) (abbreviated in the tables as PLA(2)) (D-form 12% Mw (in terms of PMMA) 200,000, amorphous)
Polypropylene-based resin (abbreviated in the tables as PP) (“Noblen” WF836DG3 produced by Sumitomo Chemical Co., MFR 7 g/10 min (230° C., 21.2N), melting point 163° C.)
Terpene resin (abbreviated in the tables as terpene) (β-pinene Tg 75° C., bromine number 4 cg/g, hydrogenation 99%)
Ethylene/propylene random copolymer (1) (abbreviated in the tables as EPC(1)) (ethylene content 1.0 wt %, Noblen FSX41E2 produced by Sumitomo Chemical Co.)
Ethylene/propylene random copolymer (2) (abbreviated in the tables as EPC(2)) (ethylene content 4.5 wt %, Noblen FS6212 produced by Sumitomo Chemical Co.)
Ethylene/methyl acrylate copolymer (abbreviated in the tables as EMA) (methyl acrylate content 20 wt %, Lotryl 20MA08 produced by Arkema)
Aliphatic polyester (abbreviated in the tables as aliphatic polyester) (Plamate PD150 PLA-polypropylene sebacate block copolymer produced by DIC, Tg: 52° C., melting point 165° C.)
Adhesive resin (1) (abbreviated in the tables as Admer) (Admer SE800 produced by Mitsui Chemicals, Inc., MFR 4 g/10 min (230° C., 21.2N))
Adhesive resin (2) (abbreviated in the tables as Umex) (Umex 1010 produced by Sanyo Chemical Industries)
Maleic anhydride-modified polyolefin-polystyrene block copolymer (abbreviated in the tables as dispersant) (Kraton FG1901 produced by Kraton Performance Polymers, Inc.)
Polybutylene succinate/adipate (abbreviated in the tables as PBSA) (Bionole 3001G produced by Showa Highpolymer Co.)

### [Coating Agent]

The following paints were used as coating agents:
Polyurethane-based paint: polyurethane-based paint WPB341 (solid component concentration 25 wt %) produced by Mitsui Chemicals Polyurethanes, Inc. was diluted with water/isopropyl alcohol (weight ratio water:isopropyl alcohol=9:1) to adjust the solid component concentration to 10 wt % solution.

### Example 1

As the resin composition (A) to constitute Layer A, 100 weight parts of Polylactic acid-based resin (1) was fed to Extruder-1 and melted at a temperature of 220° C. on the other hand, as the resin compositions (B) and (C) to constitute Layer B and Layer C, polypropylene-based resin was fed to a separate Extruder-2 and melted at a temperature of 280° C., and they were co-extruded into a sheet of two resins/three layers constitution composed of polypropylene-based resin (Layer B)/Polylactic acid-based resin (1) (Layer A)/polypropylene-based resin (Layer C), and cooled and solidified into a sheet by winding on a casting drum of a temperature of 30° C.

The sheet was pre-heated at 135° C. on rolls, drawn 5.0 times in the longitudinal direction at 140° C. on rolls, and immediately cooled to 40° C. Next, the drawn sheet was introduced into a tenter, pre-heated to a temperature of 165° C., subsequently drawn 7.5 times in the width direction at a temperature of 165° C., and after heat treating at a temperature of 165° C. while relaxing by 10% in the width direction, the sheet was cooled and wound to obtain a laminated film.

The lamination ratio of the film was as follows: Layer B/Layer A/Layer C=1:5:1.

### Example 2

A laminated film was obtained by film-forming in the same way as in Example 1, except changing the pre-heating temperature in the longitudinal direction to 80° C., the drawing temperature to 85° C., the draw ratio to 3.0 times, the pre-heating temperature in the width direction to 70° C., the drawing temperature to 75° C., the draw ratio to 3.8 times and the heat treatment temperature to 140° C.

The lamination ratio of the film was as follows: Layer B/Layer A/Layer C=1:4.8:1.

### Example 3

As the resin composition (A) to constitute Layer A, 85 weight parts of Polylactic acid-based resin (1), 10 weight parts of polypropylene-based resin, and 5 weight parts of ethylene/methyl acrylate copolymer were mixed and fed to Extruder-1 and melted at a temperature of 220° C. On the other hand, as the resin compositions (B) and (C) to constitute Layer B and Layer C, Ethylene/propylene random copolymer (1) was fed to Extruder-2 and melted at a temperature of 280° C., and thereafter, a film-forming was carried out in the same way as in Example 1 to obtain a laminated film.

The lamination ratio of the film was as follows: Layer B/Layer A/Layer C=1:5:1.

### Example 4

As the resin composition (A) to constitute Layer A, 100 weight parts of Polylactic acid-based resin (1) was fed to Extruder-1 and melted at a temperature of 220° C. On the other hand, as the resin composition (B) to constitute Layer B, 100 weight parts of Ethylene/propylene random copolymer (1) was fed to Extruder-2 and melted at 280° C., and as the resin composition (C) to constitute Layer C, 100 weight parts of Polylactic acid-based resin (2) resin was fed to Extruder-3 and melted at 200° C. 100 weight parts of Adhesive resin (1) to constitute the layer D was fed to Extruder-4 and melted at a temperature of 240° C., and they were co-extruded through a manifold to constitute Layer B/Layer D/Layer A/Layer C and, thereafter, film-formation operation was carried out in the same way as in Example 2 to obtain a laminated film.

The lamination ratio of the film was as follows: Layer B/Layer D/Layer A/Layer C=1:0.5:5:1.

### Example 5

As the resin composition (A) to constitute Layer A, 85 weight parts of Polylactic acid-based resin (1), 10 weight parts of polypropylene-based resin and 5 weight parts of ethylene/methyl acrylate copolymer were mixed and fed to Extruder-1 and melted at a temperature of 220° C. On the other hand, as the resin composition (B) to constitute Layer B, 70 weight parts of polypropylene-based resin and 30 weight parts of Ethylene/propylene random copolymer (2) were mixed, fed to Extruder-2 and melted at 260° C., and as the resin composition (C) to constitute Layer C, 100 weight parts of Ethylene/propylene random copolymer (2) was fed to Extruder-3 and melted at 260° C. 100 weight parts of Adhesive resin (1) to constitute the layer D was fed to Extruder-4 and melted at a temperature of 260° C., and they were co-extruded into a sheet through a manifold to constitute Layer B/Layer A/Layer D/Layer C, and cooled and solidified into a sheet by winding on a casting drum of a temperature of 30° C.

The sheet was pre-heated on rolls to 135° C., drawn 6.0 times in the longitudinal direction on rolls at 140° C. and immediately cooled to 40° C. Next, the drawn sheet was introduced into a tenter, pre-heated to a temperature of 150° C., subsequently drawn 8.0 times in the width direction at a temperature of 150° C., and after heat treating at a temperature of 155° C. while relaxing by 10% in the width direction, the sheet was cooled and wound to obtain a laminated film.

The lamination ratio of the film was as follows: Layer B/Layer A/Layer D/Layer C=1:6:0.5:1.

### Example 6

As shown in Table 2, the resin compositions (A) to (D) were changed and they were extrusion-molded by a co-extrusion process into a sheet through a manifold so that they would have the constitution of Layer B/Layer D/Layer A/Layer D/Layer C and cooled and solidified into a sheet by winding on a casting drum of a temperature of 30° C. The melt temperature is set in the same way as in Example 5.

A laminated film was obtained in the same way as Example 2, except changing the pre-heating temperature in the longitudinal direction to 65° C., the drawing temperature to 65° C., the draw ratio to 4.1 times, the pre-heating temperature in the width direction to 75° C., the drawing temperature to 80° C., the draw ratio to 5.1 times, and heat treating at 145° C.

### Example 7

A laminated film was obtained in the same way as in Example 6, except changing the draw ratio in the longitudinal direction to 4.6 times, the draw ratio in the width direction to 8.7 times, and the heat treatment temperature to 135° C. while relaxing by 2%.

### Examples 8 and 10

As shown in Table 2, the resin compositions (A) to (C) were changed, and the melting temperature of the resin compositions (B) and (C) were set to 220° C., followed by co-extrusion into a sheet so that they would have the constitution of Layer B/Layer A/Layer C. They were and cooled and solidified into a sheet by winding on a casting drum of a temperature of 30° C.

A laminated film was obtained by film-forming in the same way as in Example 5 except changing the draw ratio in the longitudinal direction to 4.2 times and the draw ratio in the width direction to 10.2 times.

### Example 9

As shown in Table 2, the resin compositions (A) to (C) were changed, and the melting temperature of the resin compositions (B) and (C) was set to 220° C., followed by extrusion-molding by a co-extrusion process so that they would have the constitution of Layer B/Layer A/Layer C. Then they were cooled and solidified into a sheet by winding on a casting drum of a temperature of 30° C.

A laminated film was obtained by film-forming in the same way as in Example 6, except changing the draw ratio in the longitudinal direction to 3.9 times and the draw ratio in the width direction to 4.1 times.

### Example 11

The resin compositions (A) to (D) were changed as shown in Table 2, they were extrusion-molded by a co-extrusion into a sheet by a manifold such that they would be constituted to Layer B/the layer D/Layer A/the layer D/Layer C, and cooled and solidified into a sheet by winding on a casting drum of a temperature of 30° C. The melting temperature was set to the same as that of Example 5.

A laminated film was obtained by film-forming in the same way as in Example 6, except changing the draw ratio in the longitudinal direction to 4.0 times and the draw ratio in the width direction to 4.8 times, and the heat treatment temperature to 110° C. without relaxation.

### Example 12

As shown in Table 2, the resin compositions (A) to (C) were changed, and they were extrusion-molded by a co-extrusion process into a sheet through a manifold so that they would have the constitution of Layer B/Layer A/Layer C. Then they were cooled and solidified into a sheet by winding on a casting drum of a temperature of 30° C.

The sheet was pre-heated at 135° C. on rolls, drawn 4.2 times on rolls at 140° C. in the longitudinal direction, and immediately cooled to 40° C. Corona treatment was carried out on the surface of Layer B, and the prepared polyurethane-based paint was cast on the film, followed by coating with a #12 bar coater. The film-formation was carried out thereafter in the same way as in Example 10 to obtain a laminated film.

### Example 13

As the resin composition (A) to constitute Layer A, 98 weight parts of Polylactic acid-based resin (1) and 2 weight parts of Adhesive resin (2) were mixed, fed to Extruder-1 and melted at a temperature of 220° C. On the other hand, as the resin composition (B) to constitute Layer B and as the resin composition (C) to constitute Layer C, 83 weight parts of polypropylene-based resin, 10 weight parts of Polylactic acid-based resin (1), 2 weight parts of Adhesive resin (2) and 5 weight parts of maleic anhydride-modified polyolefin-polystyrene block copolymer were mixed, fed to Extruder-2, melted at 240° C., extrusion-molded into a sheet by a co-extrusion process through a manifold so that they would have the constitution of Layer B/Layer A/Layer C. Then they were cooled and solidified into a sheet by winding on a casting drum of a temperature of 30° C.

The sheet was pre-heated at 135° C. on rolls, drawn 4.2 times rolls at 140° C. in the longitudinal direction and immediately cooled to 40° C. Next, the drawn sheet was introduced into a tenter, pre-heated to a temperature of 150° C., subsequently drawn 9.3 times in the width direction at a temperature of 150° C., and after heat treating at a temperature of 155° C. while relaxing by 10% in the width direction, cooled and wound to obtain a laminated film.

The lamination ratio of the film was as follows: Layer B/Layer A/Layer C=1:10:1.

### Example 14

A laminated film was obtained by film-forming in the same way as in Example 13, except changing the pre-heating temperature in the longitudinal direction to 80° C., the drawing temperature to 85° C., the draw ratio to 3.4 times, the pre-heating temperature in the width direction to 70° C., the drawing temperature to 75, the draw ratio to 4.1 times and the heat treatment temperature to 140° C.

### Examples 15 and 17

A laminated film was obtained by film-forming in the same way as in Example 13, except changing the resin compositions (A) to (C) as shown in Table 3.

### Examples 16 and 18

A laminated film was obtained by film-forming in the same way as in Example 14, except changing the resin compositions (A) to (C) as shown in Table 3.

### Example 19

A laminated film was obtained by film-forming in the same way as in Example 8, except changing the pre-heating temperature in the longitudinal direction to 60° C., the drawing temperature to 60° C., the draw ratio to 5.8 times, the pre-heating temperature in the width direction to 75° C., the drawing temperature to 75° C., the draw ratio to 6.7 times and the heat treatment temperature to 150° C.

### Example 20

A laminated film was obtained by film-forming in the same way as in Example 19, except changing the draw ratio in the longitudinal direction to 4.9 times and the draw ratio in the width direction to 6.0 times.

### Example 21

A laminated film was obtained by film-forming in the same way as in Example 1, except changing the resin compositions (A) to (C) as shown in Table 4, the melting temperature of the resin compositions (B) and (C) to 220° C., the draw ratio in the longitudinal direction to 3.0 times and the draw ratio in the width direction to 5.0 times.

### Example 22

A laminated film was obtained by film-forming in the same way as in Example 1, except changing the draw ratio in the longitudinal direction to 5.0 times and the draw ratio in the width direction to 3.0 times.

### Comparative Example 1

A film was obtained in the same way as in Example 1 except feeding 100 weight parts of Polylactic acid-based resin (1) to Extruder-1 and melting at 220° C. to produce a monolayer constitution.

### Comparative Example 2

A film was obtained by film-forming in the same way as in Example 1, except feeding 100 weight parts of Polypropylene-based resin (1) to Extruder-1 and melting at 280° C. to produce a monolayer constitution.

### Comparative Example 3

As the resin composition (A) which constitutes Layer A, 45 weight parts of Polylactic acid-based resin (1), 50 weight parts of polypropylene-based resin and 5 weight parts of ethylene/methyl acrylate copolymer were mixed, fed to Extruder-1 and melted at a temperature of 240° C. On the other hand, as the resin compositions (B) and (C) which constitutes Layer B and Layer C, a polypropylene-based resin was fed to Extruder-2 and melted at a temperature of 280° C., and they were co-extruded to form a 2-resin/3-layer constitution of polypropylene-based resin (Layer B)/Polylactic acid-based resin (1) (Layer A)/polypropylene-based resin (Layer C). Then they were processed into a film in the same way as in Example 1 to obtain a laminated film.

The lamination ratio of the film was as follows: Layer B/Layer A/Layer C=1:4:1.

### Comparative Example 4

As shown in Table 2, the resin compositions (A) to (D) were changed, extrusion-molded by a co-extrusion process into a sheet through a manifold so that they would have the constitution of Layer B/Layer D/Layer A/Layer D/Layer C. Then they were cooled and solidified into a sheet by winding on a casting drum of a temperature of 30° C. The melting temperature was controlled in the same way as in Example 5.

A laminated film was obtained by film-forming in the same way as in Example 2, except changing the draw ratio in the longitudinal direction to 3.8 times and the draw ratio in the width direction to 4.3 times and the heat treatment temperature to 100° C. without relaxation.

### Comparative Example 5

As shown in Table 2, the resin compositions (A) to (D) were changed, extrusion-molded by a co-extrusion process into a sheet through a manifold so that they would have the constitution of Layer B/Layer D/Layer A/Layer D/Layer C. Then they were cooled and solidified into a sheet by winding on a casting drum of a temperature of 30° C.

A laminated film was obtained by film-forming in the same way as in Example 5, except changing the draw ratio in the longitudinal direction to 2.4 times and the draw ratio in the width direction to 10.8 times and the heat treatment temperature to 110° C. without relaxation.

### Comparative Example 6

A laminated film was obtained by film-forming in the same way as in Example 6, except changing the draw ratio in the longitudinal direction to 2.8 times and the draw ratio in the width direction to 11.5 times and the heat treatment temperature to 110° C. without relaxation.

TABLE 1

| | | | | Examples | | | | | Comparative examples | | | |
|---|---|---|---|---|---|---|---|---|---|---|---|---|
| | | | | 1 | 2 | 3 | 4 | 5 | 1 | 2 | 3 | 4 |
| Layer A | Resin composition (A) | | Component | PLA(1) | PLA(1) | PLA(1) | PLA(1) | PLA(1) | PLA(1) | PP | PLA(1) | PLA(1) |
| | | | wt pts | 100 | 100 | 85 | 100 | 85 | | | 45 | 75 |
| | | | Component | | | PP | | PP | | | PP | PLA(2) |
| | | | wt pts | | | 10 | | 10 | | | 50 | 25 |
| | | | Component | | | EMA | | EMA | | | EMA | |
| | | | wt pts | | | 5 | | 5 | | | 5 | |
| Layer B | Resin composition (B) | | Component | PP | PP | EPC(1) | EPC(1) | PP | | | PP | PP |
| | | | wt pts | 100 | 100 | 100 | 100 | 70 | | | 100 | 100 |
| | | | Component | | | | | EPC(2) | | | | |
| | | | wt pts | | | | | 30 | | | | |
| Layer C | Resin composition (C) | | Component | PP | PP | EPC(1) | PLA(2) | EPC(2) | | | PP | PP |
| | | | wt pts | 100 | 100 | 100 | 100 | 100 | | | 100 | 100 |
| Layer D | Adhesive resin (D) | | Component | | | | Admer | Admer | | | | Admer |
| | | | wt pts | | | | 100 | 100 | | | | 100 |
| Layer constitution | | | | B/A/C | B/A/C | B/A/C | B/D/A/C | B/A/D/C | Monolayer | Monolayer | B/A/C | B/D/A/D/C |
| | | | | | | | | | film | film | | |
| Lamination ratio | | | | 1:5:1 | 1:4.8:1 | 1:5:1 | 1:0.5:5:1 | 1:6:0.5:1 | — | — | 1:4:1 | 1:0.5:5:0.5:1 |
| Areal ratio | | | | 37.5 | 11.4 | 37.5 | 11.4 | 48 | 11.4 | 37.5 | 37.5 | 16 |
| Film-forming property | | | | ◯ | ◯ | ◯ | ◯ | ◯ | ◯ | ◯ | X | ◯ |
| Film thickness | | | μm | 15.0 | 16.2 | 16.0 | 18.0 | 18.0 | 15 | 18 | 15 | 16.2 |
| Modulus [MD/TD] | | | GPa | 2.2/2.5 | 2.3/2.5 | 2.3/3.0 | 2.2/2.0 | 2.2/2.6 | 2.9/3.1 | 1.5/3.5 | 1.8/2.0 | 2.5/3.1 |
| Ratio of modulus | | | | 0.88 | 0.92 | 0.77 | 1.1 | 0.85 | 0.94 | 0.43 | 0.9 | 0.81 |
| Film shrinkage | | 100° C. | % | 0.2/0 | 1.2/−0.2 | 0.5/0.2 | 1.0/0.6 | 0.3/0.3 | 1.4/0.4 | 1.6/0.4 | 1.1/0.9 | 14.6/18.2 |
| [MD/TD] | | 5 min | | | | | | | | | | |
| | | 120° C. | % | 0.8/−0.4 | 2.9/−0.7 | 0.9/0.3 | 3.0/1.1 | 1.3/1.1 | 4.2/1.1 | 3.0/0.9 | 3.5/1.9 | 20.4/32.5 |
| | | 15 min | | | | | | | | | | |
| Center-line average roughness | | | nm | 46 | 87 | 35 | 65 | 30 | 76 | 42 | 195 | 46 |
| Interlayer | | Evaluation | | 1 | 2 | 2 | 3 | 3 | 5 | 5 | 1 | 5 |
| adhesion | | Peeled-off surface | | a | a | a | a | a | b | b | a | a |
| Heat sealability | | | | no HS | no HS | no HS | HS | HS | no HS | no HS | no HS | no HS |
| Biodegradability | | | | no BD | no BD | no BD | BD | no BD | BD | no BD | no BD | no BD |
| Processability | | Vapor deposition property | | ⊚ | ◯ | ⊚ | ◯ | ◯ | Δ | ◯ | Δ | X |
| | | Printing property | | ◯ | Δ | ⊚ | Δ | ⊚ | Δ | Δ | X | Δ |
| Barrier | Raw | Water vapor | g/m² · day | 19.3 | 17.3 | 20.4 | 16.8 | 21.2 | 270 | 5.8 | 42 | 24.8 |
| | film | transmission | | | | | | | | | | |
| | Vapor | Oxygen | cc/m² · | 32.5 | 16.1 | 30.1 | 14.5 | 19.8 | 10.2 | 40.3 | 160 | 55.9 |
| | deposi- | transmission | day · atm | | | | | | | | | |
| | tion | Water vapor | g/m² · day | 0.7 | 1.6 | 0.4 | 1.4 | 0.4 | 4.1 | 0.3 | 21 | 5.7 |
| | | transmission | | | | | | | | | | |

TABLE 2

| | | | | Examples | | | | |
|---|---|---|---|---|---|---|---|---|
| | | | | 6 | 7 | 8 | 9 | 10 |
| Layer A | Resin composition (A) | | Component | PLA(1) | PLA(1) | PLA(1) | PLA(1) | PLA(l) |
| | | | wt pts | 90 | 90 | 98 | 98 | 98 |
| | | | Component | aliphatic | aliphatic | Umex | Umex | Umex |
| | | | | polyester | polyester | | | |
| | | | wt pts | 10 | 10 | 2 | 2 | 2 |
| | | | Component | | | | | |
| | | | wt pts | | | | | |
| Layer B | Resin composition (B) | | Component | PP | PP | PP | PP | PP |
| | | | wt pts | 100 | 100 | 98 | 98 | 90 |
| | | | Component | | | Umex | Umex | Umex |
| | | | wt pts | | | 2 | 2 | 2 |
| | | | Component | | | | | terpene |
| | | | wt pts | | | | | 8 |
| Layer C | Resin composition (C) | | Component | EPC(2) | EPC(2) | PP | PP | PP |
| | | | wt pts | 100 | 100 | 98 | 98 | 98 |
| | | | Component | | | Umex | Umex | Umex |
| | | | wt pts | | | 2 | 2 | 2 |
| Layer D | Adhesive resin (D) | | Component | Admer | Admer | | | |
| | | | wt pts | 100 | 100 | | | |
| Coated layer | | | | | | | | |
| Layer constitution | | | | B/D/A/D/C | B/D/A/D/C | B/A/C | B/A/C | B/A/C |
| Lamination ratio | | | | 1:0.5:5:0.5:1 | 1:0.5:5:0.5:1 | 1:8:1 | 1:8:1 | 1:8:1 |
| Area ratio | | | | 21 | 40 | 43 | 16 | 43 |
| Film-forming property | | | | ◯ | ◯ | ◯ | ◯ | ◯ |
| Film thickness | | | μm | 17.7 | 17.1 | 16.4 | 17.6 | 16.3 |
| Modulus [MD/TD] | | | GPa | 3.5/3.8 | 2.4/4.3 | 2.2/2.4 | 2.0/2.1 | 2.2/2.4 |
| Ratio of modulus | | | | 0.92 | 0.56 | 0.92 | 0.95 | 0.92 |
| Film shrinkage | | 100° C. | % | 1.3/1.9 | 2.3/8.6 | 0.4/0.6 | 0.3/0.4 | 0.3/0.5 |
| [MD/TD] | | 5 min | | | | | | |
| | | 120° C. | % | 2.8/4.2 | 5.2/20.1 | 1.3/1.4 | 0.7/0.7 | 1.2/1.2 |
| | | 15 min | | | | | | |
| Center-line average roughness | | | nm | 49 | 40 | 35 | 52 | 26 |
| Interlayer | | Evaluation | | 5 | 5 | 5 | 5 | 5 |
| adhesion | | Peeled-off surface | | c | c | a | a | a |
| Heat sealability | | | | HS | HS | no HS | no HS | no HS |
| Biodegradability | | | | no BD | no BD | no BD | no BD | no BD |
| Processability | | Vapor deposition property | | Δ | ◯ | ◯ | ⊚ | ◯ |
| | | Printing property | | ◯ | ◯ | ⊚ | ◯ | ⊚ |
| Barrier | Raw | Water vapor | g/m² · day | 14.1 | 19.1 | 19.1 | 22.3 | 13.1 |
| | film | transmission | | | | | | |
| | Vapor | Oxygen | cc/m² · | 11.5 | 35 | 28.1 | 27.0 | 28.5 |
| | deposi- | transmission | day · atm | | | | | |
| | tion | Water vapor | g/m² · day | 1.1 | 1.9 | 0.4 | 0.7 | 0.3 |
| | | transmission | | | | | | |

| | | | | Examples | | Comparative examples | |
|---|---|---|---|---|---|---|---|
| | | | | 11 | 12 | 5 | 6 |
| Layer A | Resin composition (A) | | Component | PLA(1) | PLA(1) | PLA(1) | PLA(1) |
| | | | wt pts | 80 | 98 | 65 | 90 |
| | | | Component | PLA(2) | Umex | PLA(2) | aliphatic |
| | | | | | | | polyester |
| | | | wt pts | 10 | 2 | 35 | 10 |
| | | | Component | aliphatic | | | |
| | | | | polyester | | | |
| | | | wt pts | 10 | | | |
| Layer B | Resin composition (B) | | Component | PP | PP | PP | PP |
| | | | wt pts | 100 | 90 | 100 | 100 |
| | | | Component | | Umex | | |
| | | | wt pts | | 2 | | |
| | | | Component | | terpene | | |
| | | | wt pts | | 8 | | |
| Layer C | Resin composition (C) | | Component | EPC(2) | PP | PP | EPC(2) |
| | | | wt pts | 100 | 98 | 100 | 100 |
| | | | Component | | Umex | | |
| | | | wt pts | | 2 | | |
| Layer D | Adhesive resin (D) | | Component | Admer | | Admer | Admer |
| | | | wt pts | 100 | | 100 | 100 |
| Coated layer | | | | | PU | | |
| Layer constitution | | | | B/D/A/D/C | B/A/C | B/D/A/D/C | B/D/A/D/C |
| Lamination ratio | | | | 1:0.5:5:0.5:1 | 1:8:1 | 1:0.5:5:0.5:1 | 1:0.5:5:0.5:1 |
| Area ratio | | | | 21 | 43 | 26 | 28 |
| Film-forming property | | | | ◯ | ◯ | ◯ | X |
| Film thickness | | | μm | 16.8 | 16.4 | 16.4 | 17.6 |
| Modulus [MD/TD] | | | GPa | 2.4/3.6 | 2.2/2.5 | 1.7/4.2 | 2.0/4.2 |
| Ratio of modulus | | | | 0.67 | 0.88 | 0.43 | 0.48 |
| Film shrinkage | | 100° C. | % | 7.3/13.2 | 0.3/0.6 | 8.8/18.6 | 6.9/23.5 |
| [MD/TD] | | 5 min | | | | | |
| | | 120° C. | % | 15.4/18.7 | 1.2/1.4 | 12.3/26.0 | 16.3/38.1 |
| | | 15 min | | | | | |
| Center-line average roughness | | | nm | 58 | 23 | 60 | 54 |
| Interlayer | | Evaluation | | 5 | 5 | 5 | 5 |
| adhesion | | Peeled-off surface | | a | a | a | c |
| Heat sealability | | | | HS | HS | no HS | HS |
| Biodegradability | | | | no BD | no BD | no BD | no BD |
| Processability | | Vapor deposition property | | ◯ | ◯ | Δ | Δ |
| | | Printing property | | ◯ | ⊚ | Δ | Δ |
| Barrier | Raw | Water vapor | g/m² · day | 24.1 | 14 | 20.1 | 31.2 |
| | film | transmission | | | | | |
| | Vapor | Oxygen | cc/m² · | 34.6 | 10.2 | 33.8 | 65.4 |
| | deposi- | transmission | day · atm | | | | |
| | tion | Water vapor | g/m² · day | 2.2 | 0.3 | 3.9 | 4.1 |
| | | transmission | | | | | |

TABLE 3

| | | | | Examples | | | | | |
|---|---|---|---|---|---|---|---|---|---|
| | | | | 13 | 14 | 15 | 16 | 17 | 18 |
| Layer A | Resin composition (A) | | Component | PLA(1) | PLA(1) | PLA(1) | PLA(1) | PLA(1) | PLA(1) |
| | | | wt pts | 98 | 98 | 100 | 100 | 98 | 98 |
| | | | Component | Umex | Umex | | | Umex | Umex |
| | | | wt pts | 2 | 2 | | | 2 | 2 |
| Layer B | Resin composition (B) | | Component | PP | PP | PP | PP | PP | PP |
| | | | wt pts | 83 | 83 | 80 | 80 | 83 | 83 |
| | | | Component | PLA(1) | PLA(1) | PLA(1) | PLA(1) | PBSA | PBSA |
| | | | wt pts | 10 | 10 | 15 | 15 | 10 | 10 |
| | | | Component | Umex | Umex | dispersant | dispersant | Umex | Umex |
| | | | wt pts | 2 | 2 | 5 | 5 | 2 | 2 |
| | | | Component | dispersant | dispersant | | | dispersant | dispersant |
| | | | wt pts | 5 | 5 | | | 5 | 5 |
| Layer C | Resin composition (C) | | Component | PP | PP | PP | PP | PP | PP |
| | | | wt pts | 83 | 83 | 80 | 80 | 83 | 83 |
| | | | Component | PLA(1) | PLA(1) | PLA(1) | PLA(1) | PBSA | PBSA |
| | | | wt pts | 10 | 10 | 15 | 15 | 10 | 10 |
| | | | Component | Umex | Umex | dispersant | dispersant | Umex | Umex |
| | | | wt pts | 2 | 2 | 5 | 5 | 2 | 2 |
| | | | Component | dispersant | dispersant | | | dispersant | dispersant |
| | | | wt pts | 5 | 5 | | | 5 | 5 |
| Layer constitution | | | | B/A/C | B/A/C | B/A/C | B/A/C | B/A/C | B/A/C |
| Lamination ratio | | | | 1:10:1 | 1:10:1 | 1:10:1 | 1:10:1 | 1:10:1 | 1:10:1 |
| Area ratio | | | | 39 | 14 | 39 | 14 | 39 | 14 |
| Film-forming property | | | | ◯ | ◯ | ◯ | ◯ | ◯ | ◯ |
| Film thickness | | | μm | 17.9 | 18.4 | 17.7 | 18.4 | 18.0 | 18.9 |
| Modulus [MD/TD] | | | GPa | 2.1/2.5 | 2.0/2.3 | 2.3/2.6 | 2.0/2.4 | 2 2/2 5 | 2.0/2.5 |
| Ratio of modulus | | | | 0.91 | 0.83 | 0.92 | 0.87 | 0.88 | 0.8 |
| Film shrinkage | | 100° C. | % | 0.4/0.6 | 0.3/0.5 | 0.7/1.0 | 0.3/0.5 | 0.4/0.6 | 0.3/0.5 |
| [MD/TD] | | 5 min | | | | | | | |
| | | 120° C. | % | 1.2/1.4 | 0.8/0.9 | 1.8/2.2 | 1.6/2.0 | 1.9/2.5 | 1.8/2.4 |
| | | 15 min | | | | | | | |
| Center-line average roughness | | | nm | 38 | 59 | 35 | 50 | 40 | 64 |
| Interlayer | | Evaluation | | 5 | 5 | 3 | 3 | 5 | 5 |
| adhesion | | Peeled-off surface | | a | a | a | a | a | a |
| Heat sealability | | | | no HS | no HS | no HS | no HS | no HS | no HS |
| Biodegradability | | | | BD | BD | BD | BD | BD | BD |
| Processability | | Vapor deposition property | | ◯ | ⊚ | ◯ | ◯ | ◯ | ◯ |
| | | Printing property | | ⊚ | ◯ | ⊚ | ◯ | ◯ | ◯ |
| Barrier | Raw | Water vapor | g/m² · day | 20.5 | 24.1 | 18.1 | 22.5 | 22.1 | 25.9 |
| | film | transmission | | | | | | | |
| | Vapor | Oxygen | cc/m² · | 25.7 | 28.7 | 25.8 | 29 | 28.6 | 30.3 |
| | deposi- | transmission | day · atm | | | | | | |
| | tion | Water vapor | g/m² · day | 0.8 | 1.1 | 0.7 | 0.9 | 1.4 | 1.9 |
| | | transmission | | | | | | | |

TABLE 4

| | | | | Examples | | | |
|---|---|---|---|---|---|---|---|
| | | | | 19 | 20 | 21 | 22 |
| Layer A | Resin composition (A) | | Component | PLA(1) | PLA(1) | PLA(1) | PLA(1) |
| | | | wt pts | 98 | 98 | 98 | 98 |
| | | | Component | Umex | Umex | Umex | Umex |
| | | | wt pts | 2 | 2 | 2 | 2 |
| | | | Component | | | | |
| | | | wt pts | | | | |
| Layer B | Resin composition (B) | | Component | PP | PP | PP | PP |
| | | | wt pts | 98 | 98 | 98 | 98 |
| | | | Component | Umex | Umex | Umex | Umex |
| | | | wt pts | 2 | 2 | 2 | 2 |
| | | | Component | | | | |
| | | | wt pts | | | | |
| Layer C | Resin composition (C) | | Component | PP | PP | PP | PP |
| | | | wt pts | 98 | 98 | 98 | 98 |
| | | | Component | Umex | Umex | Umex | Umex |
| | | | wt pts | 2 | 2 | 2 | 2 |
| Layer constitution | | | | B/A/C | B/A/C | B/A/C | B/A/C |
| Lamination ratio | | | | 1:8:1 | 1:8:1 | 1:8:1 | 1:8:1 |
| Area ratio | | | | 39 | 29 | 15 | 15 |
| Film-forming property | | | | ◯ | ◯ | ◯ | ◯ |
| Film thickness | | | μm | 18.0 | 18.1 | 18.2 | 18.1 |
| Modulus [MD/TD] | | | GPa | 6.6/6.8 | 4.8/6.4 | 2.0/2.2 | 2.3/2.1 |
| Ratio of modulus | | | | 0.97 | 0.75 | 0.91 | 1.1 |
| Film shrinkage | | 100° C. | % | 9.2/18.9 | 5.9/13.8 | −2.5/1.0 | −0.3/−3.8 |
| [MD/TD] | | 5 min | | | | | |
| | | 120° C. | % | 9.7/19.5 | 6.3/14.5 | −2.0/1.8 | 0.1/−3.3 |
| | | 15 min | | | | | |
| Center-line average roughness | | | nm | 83 | 78 | 50 | 52 |
| Interlayer | | Evaluation | | 5 | 5 | 5 | 5 |
| adhesion | | Peeled-off surface | | a | a | a | a |
| Heat sealability | | | | no HS | no HS | no HS | no HS |
| Biodegradability | | | | no BD | no BD | no BD | no BD |
| Processability | | Vapor deposition property | | Δ | ◯ | ◯ | ◯ |
| | | Printing property | | Δ | Δ | ◯ | ◯ |
| Barrier | Raw | Water vapor | g/m² · day | 21.1 | 22.9 | 25.5 | 25.6 |
| | film | transmission | | | | | |
| | Vapor | Oxygen | cc/m² · | 31.8 | 32.5 | 34.8 | 34.7 |
| | deposi- | transmission | day · atm | | | | |
| | tion | Water vapor | g/m² · day | 1.3 | 1.5 | 1.8 | 1.8 |
| | | transmission | | | | | |

As shown in Tables 1 to 4, it is found that the film is excellent in film-forming property, processability and gas barrier property.

The abbreviations used in the above-mentioned tables are as follows:
MD: longitudinal direction
TD: transverse (width) direction
PU: polyurethane-based paint.

### INDUSTRIAL APPLICABILITY

The film is excellent in processability while comprising polylactic acid-based resin as the main component, and while maintaining the productivity inherent in polyolefin film, and can serve effectively as material for wrapping film.

1. A laminated film comprising:
Layer A of a resin composition (A) composed mainly of a polylactic acid-based resin;
Layer B of a resin composition (B) composed mainly of a polyolefin-based resin laminated to Layer A; and
Layer C of a resin composition (C) laminated to Layer A,
wherein the modulus in a longitudinal direction of the film is 2.0 to 7.0 GPa and after being subjected to heat treatment at 100° C. for 5 minutes, thermal shrinkage in the longitudinal direction and in a width direction of the film is 10% or less and 20% or less, respectively.

2. The laminated film as described in claim 1, wherein, after being subjected to heat treatment at 120° C. for 15 minutes, the thermal shrinkage in the longitudinal direction and in the width direction is 10% or less and 20% or less, respectively.

3. The laminated film as described in claim 1, having a center-line average roughness Ra of a surface of Layer B in the laminated film of 10 nm to 85 nm.

4. The laminated film as described in claim 1, wherein the resin composition (A) contains a polyolefin-based resin.

5. The laminated film as described in claim 1, wherein the resin composition (B) comprises as its main component at least one polyolefin-based resin selected from the group consisting of polypropylene, ethylene-propylene random copolymer, ethylene-propylene block copolymer, ethylene-propylene-butene random copolymer and propylene-butene random copolymer.

6. The laminated film as described in claim 1, wherein the resin composition (C) comprises as its main component polypropylene, ethylene-propylene random copolymer, ethylene-propylene block copolymer, ethylene-propylene-butene random copolymer, propylene-butene random copolymer, or polylactic acid-based resin.

7. The laminated film as described in claim 1, wherein Layers A and B and/or Layers A and C are laminated via Layer D of an adhesive resin (D).

8. The laminated film as described in claim 1, wherein at least one resin composition selected from the group consisting of the resin composition (A), the resin composition (B) and the resin composition (C) contains an adhesive resin (E).

9. The laminated film as described in claim 1, wherein at least one resin composition selected from the group consisting of the resin composition (A), the resin composition (B) and the resin composition (C) contains a drawing auxiliary (F).

10. The laminated film as described in claim 1, wherein Layer C has heat sealability.

11. The laminated film as described in claim 1, wherein a ratio of the modulus in the longitudinal direction to the modulus in the width direction ((modulus in the longitudinal direction)/(modulus in the width direction)) is 0.3 to 0.75.

12. The laminated film described in claim 1, further comprising a vapor deposited layer composed of a metal or a metal oxide provided on a side of Layer B in the laminated film.

13. The laminate film as described in claim 12, further comprising a coated layer provided between the vapor deposited layer composed of the metal or the metal oxide and Layer B in the laminated film.

14. A packaging material that contains a laminated film as described in claim 1.

15. The laminated film as described in claim 2, having a center-line average roughness Ra of a surface of Layer B in the laminated film of 10 nm to 85 nm.

16. The laminated film as described in claim 2, wherein the resin composition (A) contains a polyolefin-based resin.

17. The laminated film as described in claim 3, wherein the resin composition (A) contains a polyolefin-based resin.

18. The laminated film as described in claim 2, wherein the resin composition (B) comprises as its main component at least one polyolefin-based resin selected from the group consisting of polypropylene, ethylene-propylene random copolymer, ethylene-propylene block copolymer, ethylene-propylene-butene random copolymer and propylene-butene random copolymer.

19. The laminated film as described in claim 3, wherein the resin composition (B) comprises as its main component at least one polyolefin-based resin selected from the group consisting of polypropylene, ethylene-propylene random copolymer, ethylene-propylene block copolymer, ethylene-propylene-butene random copolymer and propylene-butene random copolymer.

20. The laminated film as described in claim 4, wherein the resin composition (B) comprises as its main component at least one polyolefin-based resin selected from the group consisting of polypropylene, ethylene-propylene random copolymer, ethylene-propylene block copolymer, ethylene-propylene-butene random copolymer and propylene-butene random copolymer.
